(19) United States
(12) Patent Application Publication
(10) Pub. No.: US 2023/0225328 A1
(43) Pub. Date: Jul. 20, 2023

(54) ANTIMICROBIAL FILMS

(71) Applicant: VIRGINIA TECH INTELLECTUAL PROPERTIES, INC., Blacksburg, VA (US)

(72) Inventors: William DUCKER, Blacksburg, VA (US); Saeed BEHZADINASAB, Blacksburg, VA (US); Mohsen HOSSEINI, Blacksburg, VA (US); Gary WHITING, North East, MD (US)

(21) Appl. No.: 17/928,337

(22) PCT Filed: May 27, 2021
(86) PCT No.: PCT/US2021/034511

§ 371 Date: Nov. 29, 2022

Related U.S. Application Data
(60) Provisional application No. 63/032,014, filed on May 29, 2020.
(60) Provisional application No. 63/116,254, filed on Nov. 20, 2020.

(51) Int. Cl. A01N 59/20; A01N 25/10; A01N 59/16; A01N 59/06; A01N 59/00; A01N 25/34; A01P 1/00

(52) U.S. Cl. CPC A01N 59/20; A01N 25/10; A01N 59/16; A01N 59/06; A01N 59/00; A01N 25/34; A01P 1/00

(57) ABSTRACT

In one aspect, the disclosure relates to antimicrobial films for use on high-touch surfaces in medical, commercial, and residential settings and methods of making the same. The films and coatings are robust and retain activity over time and are optimized to minimize diffusion time of virus particles as well as bacterial and fungal pathogens to the inactivating layers and/or particles in the films and coatings. In another aspect, the films and coatings are capable of inactivating multiple virus, bacteria, and fungi types, can be applied as sprayable coatings or adhesive backed films, or can be incorporated into fabrics. In still another aspect, the films and coatings can be formulated as transparent or can be a neutral color such as gray or white.

### CROSS REFERENCE TO RELATED APPLICATIONS

This application claims the benefit of U.S. Provisional Application No. 63/032,014 filed on May 29, 2020, and U.S. Provisional Application No. 63/116,254 filed on Nov. 20, 2020, each of which is incorporated herein by reference in its entirety.

### STATEMENT REGARDING FEDERALLY SPONSORED RESEARCH OR DEVELOPMENT

This invention was made with government support under grant number CBET-1902364 awarded by the National Science Foundation. The government has certain rights in the invention.

### BACKGROUND

First identified in Wuhan, China, in December 2019, severe acute respiratory syndrome coronavirus 2 (SARS-CoV-2) has been declared a pandemic by the World Health Organization, affecting nearly every country in the world and with infections numbering in the tens of millions and deaths surpassing one million.

COVID-19, the disease caused by SARS-CoV-2, affects multiple organ systems and, in severe cases, can lead to acute respiratory distress syndrome, abnormal blood clotting, organ failure, pneumonia, septic shock, pediatric multisystem inflammatory syndrome, and more. However, many symptoms are respiratory and include cough, shortness of breath, low blood oxygen saturation, loss of smell and taste, and ground glass opacities in the lungs appearing on chest X-ray or CT scan, among others. Severe cases require hospitalization with courses of treatment that can include supplemental oxygen and even mechanical ventilation.

A key factor leading to the emergence of SARS-CoV-2 as a pandemic is the ease of transmission among individuals through respiratory droplets. In some cases, however, a mechanism of transmission exists wherein droplets from an infected individual land on an object and another individual touches the object which is now coated with infective particles. Infection from contaminated surfaces is known for other viruses and may occur for SARS-CoV-2. The US Centers for Disease Control and Prevention has recommended frequent disinfection of communal surfaces to reduce transmission. Recent work has shown that SARS-CoV-2 remains viable on solids for extended periods; it is viable for up to one week on hard surfaces such as glass and stainless steel. This has led to widespread fear of touching communal objects that may have been touched by other individuals on a previous occasion, and widespread efforts to decontaminate surfaces during the COVID-19 pandemic.

The ongoing COVID-19 pandemic has created a need for coatings that reduce infection from SARS-CoV-2 via surfaces. Such a coating could be used on common touch surfaces (e.g. door handles and railings) to reduce both disease transmission and fear of touching objects.

Other viruses also pose significant risks to human health through surface contamination, including, but not limited to, influenza viruses, rhinoviruses, other coronaviruses, norovirus, respiratory syncytial virus, parainfluenza virus, hepatitis A, B, and/or C, rotavirus, enteric adenoviruses, Zika virus, coxsackievirus, cytomegalovirus, Epstein-Barr virus, varicella zoster virus, measles virus, mumps virus, Rubella virus, Ebola virus, and the like. In addition, as can be seen from epidemics of recent years (i.e., SARS in 2002-2004, MERS in 2012, and the like), new viruses occasionally enter the human population, a phenomenon that is only expected to increase with climate change and high levels of human migration. Similarly, bacterial and fungal infections can also be transmitted by contaminated surfaces in hospital, transportation, and community settings. These include, but are not limited to, Staphylococcus aureus (including methicillin-resistant strains), Pseudomonas aeruginosa, Enterococcus faecalis, Escherichia coli, Acinetobacter baumannii, Stenotrophomonas maltophilia, Mycobacterium avium, Mycobacterium chimaera, Mycobacterium abscessus, Streptococcus pyogenes, Streptococcus pneumoniae, Haemophilus influenzae, Legionella species, Candida albicans, Candida auris, and Aspergillus niger. It would thus be desirable if a surface treatment or coating could simultaneously inactivate multiple pathogen types.

Furthermore, bacterial and fungal diseases can also be transmitted to healthy humans via contact with infected objects. Hospital-acquired microbial infections are estimated to cost over $120 billion annually; however, standard surface treatments involving sprays or mists of antimicrobial chemicals are not advisable and may not be permitted in patient rooms, food-preparation facilities, and the like.

Some viral particles have been shown to be detectable on solids for up to a week, so it would be highly desirable if an antimicrobial coating or wrap could be designed to rapidly inactivate these particles so that active viruses, bacteria, and fungi are not transmitted to a second person. It would further be desirable if the coating or wrap was additionally active against bacterial and/or fungal pathogens. Ideally, the coating or wrap would be robust, lasting for up to several months and surviving exposure to high concentration ethanol as well as bleach solutions. The coating or wrap could be used on often-handled objects and surfaces including those with irregular shapes such as, for example, door handles, shopping cart handles, light switches, phones and tablets, credit card readers and ATM PIN pads, and the like, to inhibit disease transmission and other surfaces where antimicrobial treatment is desirable, including those that may not be often-handled but are required by government or facility regulations to be regularly cleaned. Such a coating or wrap could be used in commercial, residential, and even medical settings, could be removed from surfaces by cleaning or peeling, and could be transparent or neutral in color, depending on the application site. These needs and other needs are satisfied by the present disclosure.

### SUMMARY

In accordance with the purpose(s) of the present disclosure, as embodied and broadly described herein, the disclosure, in one aspect, relates to antimicrobial films for use on high-touch and other surfaces in medical, commercial, and residential settings and methods of making the same. The films and coatings are robust and retain activity over time and can optionally be optimized to minimize diffusion time of virus particles as well as bacterial and fungal pathogens to the inactivating layers and/or particles and to minimize the diffusion of active ingredients to the microbes in the films and coatings. In another aspect, the films and coatings are capable of inactivating multiple virus, bacteria, and fungi types, can, in some aspects, be applied as sprayable coatings or adhesive backed films, or can be incorporated into fabrics. In still another aspect, the films and coatings can be formulated as transparent or can be a neutral color such as gray or white.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic showing features including porosity, inactivation layer, and diffusion according to one embodiment of the disclosed films and coatings.

FIG. 2 shows an XRD pattern of the CuO coating showing that it is highly pure monoclinic CuO. The numbers on each peak indicate the Miller Indices of the scattering planes. Comparison to XRD of the coating before thermal treatment (Cu₂O) shows effectively complete oxidation.

FIGS. 3A-3D show XPS results of the fabricated CuO film. FIG. 3A: Survey spectrum showing the preponderance of copper and oxygen on the surface. FIG. 3B: Cu2p_{3/2} spectrum showing both elemental copper and CuO on the surface. FIG. 3C: Oxygen spectrum. FIG. 3D: CuLMM Auger Kinetic Energy.

FIGS. 4A-4C show SEM images of cupric oxide films. FIG. 4A: Plan view of the coating showing the porosity. FIG. 4B: Higher magnification showing the necks produced by early-stage sintering of particles. Arrows show necks. FIG. 4C: Cross-sectional view of the coating.

FIG. 5A shows viral titer of SARS-CoV-2 on coating of CuO. O=uncoated glass and x=CuO coating on glass. Shaded region represents the 95% confidence interval. The detection limit is 1.95. The coating thickness is approximately 74 μm. FIG. 5B shows viral titer of SARS-CoV-2 on coating of CuO. O=uncoated glass and x=CuO coating on glass. Shaded region represents the 95% confidence interval. The detection limit is 1.95. The coating thickness is approximately 32 μm.

FIG. 6 shows the effect of equilibration with leachate from coating for 1 h or 24 h on the viability of SARS-CoV-2. Three different liquids are compared: the medium (negative control), leachate from the CuO coating and leachate from the Cu₂O coating (positive control). The virus was never in contact with the solid. Leachate from CuO did not significantly inactivate the virus, even over 24 h of exposure.

FIGS. 7A-7C shows a schematic of various modes of enabling contact between the virus and the active surface. FIG. 7A: microbial and viral particles in a static droplet may take several hours to contact a surface by diffusion. FIG. 7B: A drying droplet is superior to a static droplet because of advection and a smaller volume, although time to contact the surface may still be variable. FIG. 7C: Imbibition quickly (i.e., on the scale of minutes or less) brings the viral suspension into close contact with the active material. Contact is also improved by drying of the droplet. The imbibed droplet produces faster drying as shown in FIG. 9.

FIG. 8 shows imbibition of a 5 μL water droplet by porous CuO coatings as a function of time and relative humidity (RH). Even at 95% humidity, a 5 μL droplet is imbibed within about 80 s. Imbibition at 0% humidity (complete at about ˜60 s) and at 100% humidity (no imbibition at 80 s) and for a non-porous solid (no imbibition) shown for comparison.

FIG. 9 shows drying of a 5 μL droplet on CuO porous coating on glass compared to drying time on non-porous glass at 22° C. and 35% relative humidity. Symbols indicate average values, and the highlighted regions depict the standard deviation at each time point for three replicates. The average drying rates are 16.85±0.23 percent/min for water/CuO, 13.74±0.7 for saliva/CuO, 4.58±0.1 for water/glass and 4.34±0.08 for saliva/glass. The drying rate of a droplet on porous CuO film is thus about 3 times faster for both pure water (student's t-test, one tail unpaired p=1.3×10⁻⁴) and for saliva (student's t-test, one tail unpaired p=1.1×10⁻³).

FIG. 10 shows viral titer of SARS-CoV-2 on uncoated glass (squares) and glass with transparent coating consisting of Cu₂O and polydopamine (PDA) coating (×). The quantity of virus is reduced by 68.02% in one minute and by 99.87% within one hour.

FIG. 11 shows Colony forming units (CFU) of bacteria on transparent coating consisting of Cu₂O and polydopamine (PDA). The dotted line at the bottom represents the detection limit and the dotted lines at the top represents the bacterial input. P.A.=Pseudomonas aeruginosa, MRSA=methicillin-resistance Staphylococcus aureus. Each symbol represents the average of the log of each of three measurements.

FIG. 12A shows that, in some aspects, the disclosed coatings (Cu₂O and PDA) are transparent. In this photographic image, a sample coating held in front of a computer monitor cleanly shows the image on the monitor. Color (here shown as shades of gray lettering) from the computer screen can be clearly be seen through the transparent coating. FIG. 12B shows UV-visible data for exemplary transparent coatings on glass. The Cu₂O and polydopamine has a coating on one side and the PDA/Cu has two coatings (one on each side). Transmittance was measured relative to air. FIG. 12C shows a smart phone with a screen cover. On the left is a screen cover without an antimicrobial coating, and on the right is a screen cover with an antimicrobial of Ag₂O and silicate made by the sol-gel method. Color (here shown as a grayscale image of leaves) from the smart phone screen can be clearly be seen through the transparent coating. FIG. 12D shows a supermarket check-out screen with an antimicrobial coating of Ag₂O and silica made by the sol-gel method over the pay button. The features of the screen are clearly visible though the coated glass. FIG. 12E shows UV-visible data for a glass slide with an antimicrobial coating of Ag₂O and silica made by the sol-gel method. The transmittance is measured relative to uncoated glass.

FIG. 13 shows viral titer for SARS-CoV-2 on transparent coating consisting of Cu and polydopamine (PDA). The dotted line represents the detection limit. Each symbol represents the average of the log of each of three measurements.

FIG. 14 shows colony forming units (CFU) of bacteria on transparent coating consisting of Cu and polydopamine (PDA). The dotted line at the bottom represents the detection limit and the dotted lines at the top represents the bacterial input. P.A.=Pseudomonas aeruginosa, MRSA=methicillin-resistant Staphylococcus aureus. Each symbol represents the average of the log of each of three measurements.

FIG. 15A shows a time course of viable titer of SARS-CoV-2 on solids, with and without a coating of cuprous oxide microparticles bound with polyurethane (Cu₂O/PU). Data is shown for coated glass Individual circular data points (O) represent each independent measurement and the x symbol represents the mean of the log of independent measurements. The detection limit was 90 TCID₅₀/mL (shown with a dotted line). Experimental results where virus was not detected are plotted at 90 TCID₅₀/mL and are included in the average as 90 TCID₅₀/mL. SARS-CoV-2 is inactivated much more rapidly on the coated surface than on the bare surface. FIG. 15B shows an identical experiment conducted on a stainless steel surface. FIG. 15C shows a time course of viable titer of SARS-CoV-2 on glass coated in Cu₂O/PU that was subjected to 5 cycles of exposure to SARS-CoV-2 plus soaking in 70% ethanol prior to measuring the time course. The uncoated glass was also subjected to the disinfection cycles. O=data point; x=average, dotted line is the detection limit. FIG. 15D shows viral titer for samples stored under water for 13 days. Samples were tested 30 minutes after removal from water. Individual circular data points represent each independent measurement and the x symbol represents the mean of the log of independent measurements. Data points where virus was not detected are plotted at or near 90 TCID₅₀/mL (shown with a dotted line) and are included in the average as 90 TCID₅₀/mL. The uncoated surface was not stored under water. SARS-CoV-2 is inactivated much more rapidly on the coated solid than on the bare solid. FIG. 15E shows viral titer for samples on glass for short periods of time.

FIG. 16A shows viral titer for SARS-CoV-2 on coating of ZnO tetrapod and polyurethane (PU) compared to uncoated glass. The x represents the average of the data points and the dotted line represents the detection limit. FIG. 16B shows viral titer for SARS-CoV-2 on coating of ZnO on ZnO/TEOS coatings. Diamonds and circles show independent measurements, while x represents the log of the average at each time, and the dashed line shows the detection limit of 90 TCID50/mL.

FIG. 17A shows colony forming Units (CFU) for Staphylococcus aureus on transparent coating with Ag₂O in a silica matrix. O=uncoated glass, +=coating of 1×Ag₂O, x=coating of 2×Ag₂O. Each symbol represents the average of the log of each of three measurements. Shaded region is the 95% confidence interval. The detection limit is 1.95. FIG. 17B shows colony forming Units (CFU) for Pseudomonas aeruginosa on transparent coating with Ag₂O in a silica matrix. O=uncoated glass, +=coating of 1×Ag₂O, x=coating of 2×Ag₂O. Each symbol represents the average of the log of each of three measurements. Shaded region is the 95% confidence interval.

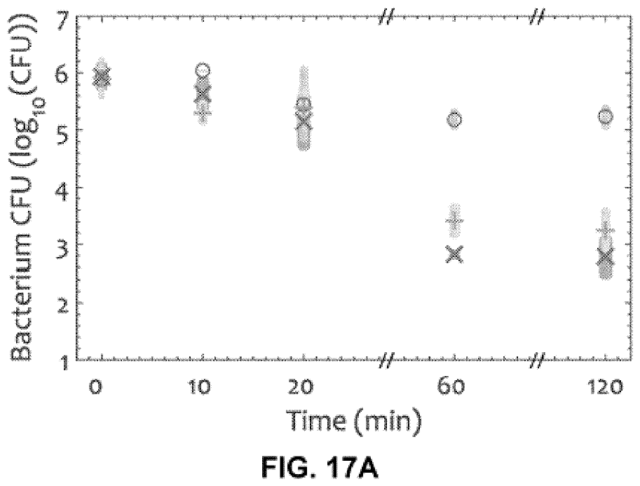

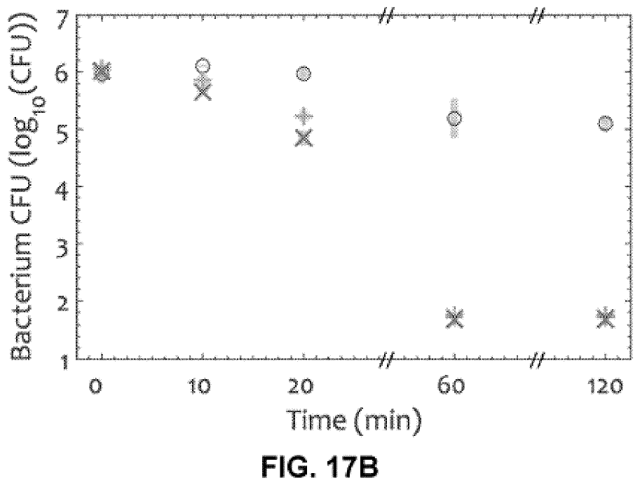

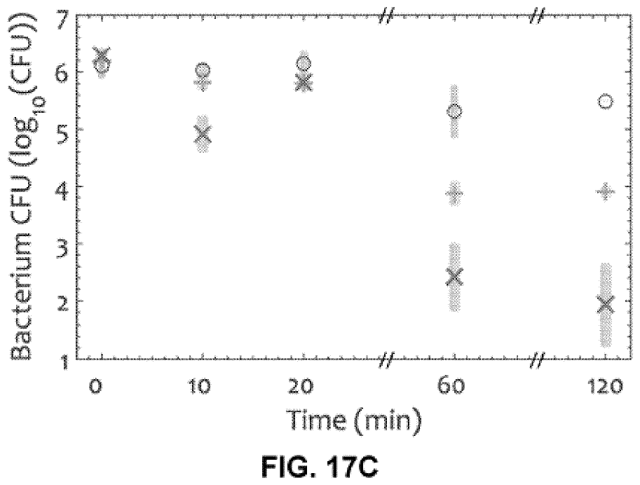

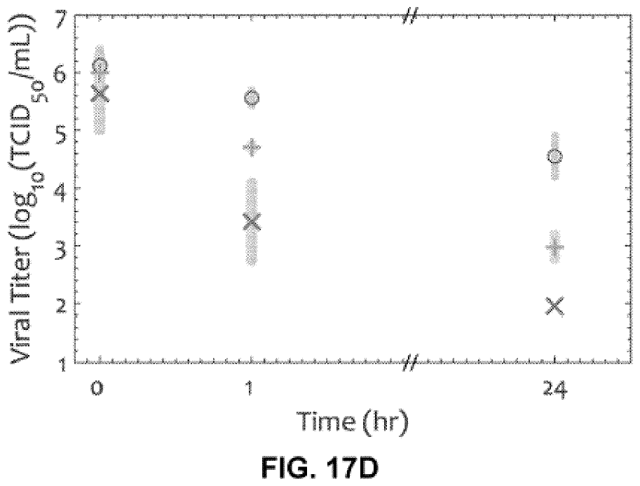

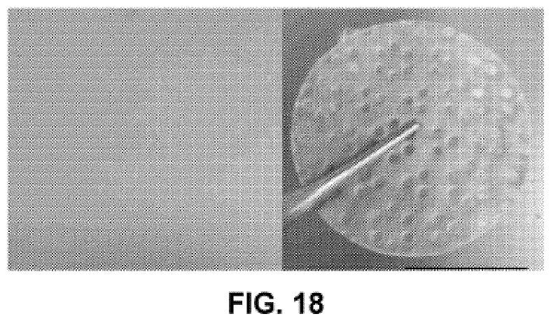

The detection limit is 1.95. FIG. 17C shows colony forming Units (CFU) for methicillin-resistant Staphylococcus aureus (MRSA) on transparent coating with Ag₂O in a silica matrix. O=uncoated glass, +=coating of 1×Ag₂O, x=coating of 2×Ag₂O. Each symbol represents the average of the log of each of three measurements. Shaded region is the 95% confidence interval. The detection limit is 1.95. FIG. 17D shows viral titer of SARS-CoV-2 on transparent coating with Ag₂O in a silica matrix. O=uncoated glass, +=coating of 1×Ag₂O, x=coating of 2×Ag₂O. Each symbol represents the average of the log of each of three measurements. Shaded region is the 95% confidence interval. The detection limit is 1.95.

FIG. 18 Photograph of melt-blown polypropylene fibrous coating with Cu₂O particles attached without Cu₂O (left) and with Cu₂O (right).

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

One way to reduce transmission of COVID-19 and other viruses, as well as diseases caused by microbial and fungal pathogens, via surfaces is to engineer coatings and films that inactivate viruses and other microbes and to use the coatings and films on communal objects such as door handles, elevator buttons, and gas pumps. Possible applications extend to hospitals, schools, public transportation, etc. In one aspect, the coatings and films can reduce the inactivation period from one week to minutes or hours or whatever the expected interval is between users of the coated object. In one aspect, described herein is a surface coating with cuprous oxide and cupric oxide as the active ingredients. Cu₂O inactivates 99.9% of SARS-CoV-2 in one hour and CuO reduces the infectivity of the virus by 99.9% in one hour. In a further aspect, the dramatic reduction in longevity of the virus from one week to one hour on stainless steel or glass shows that coatings have the potential to effect disinfection between users of communal objects. Similarly, coatings formulated with ZnO, Ag₂O, and other metal oxides disclosed herein can inactivate viral particles, fungi, and bacteria in a short time period; exemplary applications are provided in the Examples.

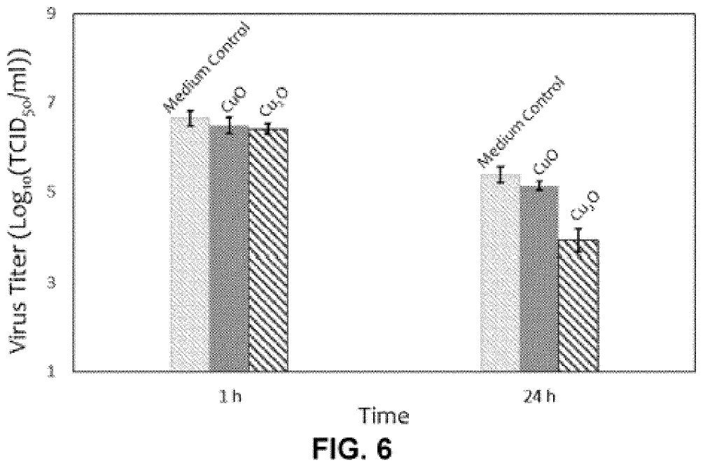

Although cupric oxide (CuO) is not as common as cuprous oxide (Cu₂O) for antimicrobial use, previously reported antimicrobial and antibacterial properties suggest potential against SARS-CoV-2. In one aspect, a significant advantage of CuO is that the fully oxidized state enables sintering of particles into a porous coating with a very large surface area. In a further aspect, without wishing to be bound by theory, the mechanism of the antimicrobial and antibacterial properties of solid-state cupric oxide is believed to stem from contact between the microbial species and the oxide; release of ions alone appears to be ineffective (see FIG. 6). The high area of a sintered, porous film enables good contact between the microbe and the CuO solid.

In one aspect, a porous coating can be beneficial due to greater surface area, protection of active antimicrobial metal and/or metal oxide particles from abrasion, or due to the ability of the pores to imbibe viral and microbial particles, thereby facilitating direct contact of the viral and microbial particles with the metal and/or metal oxides.

In another aspect, the practical use of a CuO coating may depend on its cytotoxicity to human cells. Semisch et al. investigated the cytotoxicity of CuO microparticles (<5 μm) against A549 and HeLa S3 cells after 24 hours of incubation. Their results did not show any sign of cytotoxic effect on either cells. Additionally, the median lethal dose (LD₅₀) of cupric oxide is 2500 mg/kg (oral) and 2000 mg/kg (dermal) for rat, and no skin irritation or sensitization has been reported.

Herein disclosed is the effect of a cupric oxide coating on SARS-CoV-2 in droplets. In one aspect, viable SARS-CoV-2 is used rather than a proxy virus, which means that experiments must be done under BSL-3 conditions but restricts the range of possible experiments. In a further aspect, use of active SARS-CoV-2 enables demonstration of real application to the ongoing COVID-19 pandemic. The infectivity was tested on Vero E6 cells, which are kidney cells from the African green monkey.

In one aspect, a key parameter is a short time period for inactivation in order to minimize the probability that deposited droplets can infect a future user of the contaminated object. Further in this aspect, the time taken includes the time for the virus to transport to the active ingredient in the film or for the active ingredient to diffuse to the microbe. When the droplet lands on an impermeable solid, in one aspect, the microbe must diffuse through the droplet to reach the solid. Further in this aspect, with time, the droplet evaporates, which lessens the required distance for transport and causes convection, which will also affect transport.

In one aspect, to speed contact between the microbe and the solid surface, disclosed herein is a thin, porous, hydrophilic, CuO film that draws aqueous droplets into its interior. In a further aspect, within the interior of the film, the transport distances are much shorter (μm) than for a droplet sitting on the surface (mm). Still further in this aspect, drying times can also be shorter. In any of these aspects, these effects should speed the collision between the microbe and the active surface or active ingredient. In one aspect, the interior space of the film also has much greater contact area of active ingredient that a planar surface. These results show that one exemplary CuO film reduced infectivity by 99.8% in about 30 minutes. In some experiments, other metal oxides including, but not limited to, Cu₂O, ZnO, MgO, TiO₂, Ag₂O, Fe₂O₃, Sb₂O₃, Al₂O₃, and any combination thereof, or other metals including metallic copper, metallic zinc, and/or metallic silver, and combinations thereof, can be used, with or without a polymeric or fibrous component such as, for example, quaternary ammonium polymers, polyethylene, polystyrene, polyvinylchloride, polydimethylsiloxane, a polyester, an acrylic, a nylon, an epoxy, a polyurethane, polypropylene, polyethylene, nanocellulose, metal wire, cellulose or a derivative thereof, chitin or a derivative thereof, wool, silk, cotton, flax, hemp, or any combination thereof. In some aspects, fibers can be treated with the films prior to processing to form the fibers into cloth or mats, thereby rendering the cloth or mats antimicrobial.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a virus,” “a film,” or “a solvent,” includes, but is not limited to, combinations of two or more such viruses, films, or solvents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a polyurethane refers to an amount that is sufficient to achieve the desired improvement in the property modulated by the formulation component, e.g. achieving the desired level of binding together of metal oxide particles. The specific level in terms of wt % in a composition required as an effective amount will depend upon a variety of factors including the surface on which the films and coatings disclosed herein are to be deposited, expected level of use and/or handling of the treated surfaces, solvent used to deposit the metal oxide or other particles, and pore size and hydrophilicity of the coatings and films.

As used herein, the terms “optional” or “optionally” means that the subsequently described event or circumstance can or cannot occur, and that the description includes instances where said event or circumstance occurs and instances where it does not.

As used herein, “respiratory droplet” refers to a droplet having a size from slightly less than 5 μm to 1000 μm, or of from about 5 μm to about 100 μm, that contains saliva, mucus, and other mater derived from the respiratory tract of an individual through everyday acts such as breathing, singing, and talking, through actions of individuals suffering an illness including sneezing, coughing, or vomiting, or through a medical procedure that generates aerosols such as, for example, cardiopulmonary resuscitation or intubation. In one aspect, respiratory droplets can contain microbial particles.

“Virus particles” or “virions” as used herein refer to independent particles of a viral infectious agent. Intact and infective virus particles typically contain viral DNA or RNA, depending on the virus type, a protein coat, and an outside lipid envelope, although not all viruses will have a lipid envelope. In one aspect, the films and coatings disclosed herein are useful for inactivating virus particles.

To “inactivate” a virus or microorganism is to render it noninfective. Viruses can be inactivated in a number of ways including through disruption of the lipid envelope for enveloped viruses, denaturation of surface proteins or proteins in the envelope by altering the local environment of the proteins, chemical inactivation, denaturation using a solvent or detergent, acid treatment, pasteurization, binding to an inanimate object, or another method. Bacteria and fungi can be inactivated through disruption of cell walls or cell membranes, permeabilization of cell membranes, disruption of cellular machinery responsible for the production of DNA, RNA, or proteins, and/or disruption of other metabolic pathways. In one aspect, inactivation of a virus or microorganism can render 100% of the virus particles or microbial cells in a sample noninfective, or about 99%, 95%, 90%, 85%, 80%, 75%, or about 70% of the virus particles or microbial cells in a sample noninfective. In one aspect, it is not necessary to render 100% of the virus particles or microbial cells in a sample noninfective because simply significantly reducing the number of virus particles or microbial cells greatly reduces the risk of infection.

If a substance, film, coating, or article is “antimicrobial,” then that substance, film, coating, article, or the like is capable of inactivating all or a significant portion of at least one species of virus particles, bacteria, fungi, and combinations thereof that come into contact therewith, or inactivating enough virus particles, or inactivating or killing enough bacteria, and/or fungi that a subject contacting the substance, film, coating, or article will not contract a viral, bacterial, and/or fungal disease caused by the at least one species by touching or contacting the substance, film, coating, or article.

A “film” as used herein refers to a thin layer of material. The film can be formed in situ (as by spraying a polymer or monomer onto a surface) or can be formed externally and applied to a surface (as in an adhesive-backed, flexible film that can be applied to a door handle, elevator button, or other existing object). In some aspects, films may include articles such as, for example, screen protectors. In one aspect, a screen protector can also incorporate an antimicrobial film. In any of these aspects, the films can have thicknesses from a few nm up to 1 mm. In one aspect, the terms “coating” or “wrap” can be used to refer to the disclosed antimicrobial films.

A “matrix” as used herein refers to any organic or inorganic component used in association with a metal or metal oxide to form an antimicrobial film. Exemplary matrices include, but are not limited to, polymers (e.g. polyurethane, polydopamine, polymethylmethyacrylate), silica and silicate as well as mixtures thereof, textiles, and combinations thereof.

“TCID₅₀” or “fifty-percent tissue culture infective dose” refers to the amount of infectious microbe that is required to kill at least 50% of infected host cells, for example, in tissue culture.

A “robust” film or coating is one that persists on an object, article, or surface during normal usage. For example, a robust film or coating on a light switch, door handle, or faucet handle would be capable of repeated and/or sustained contact with hands or gloves without wearing off or disintegrating. In some aspects, a robust film or coating is resistant to scratching and abrasion, extremes of temperature and/or weather, spills of liquids, and the like. In any of these aspects, a robust film or coating remains active (i.e., retains antimicrobial activity at a high level in this instance) and does not lose a significant amount of mass over time. In one aspect, in instances when a small amount of mass is lost from, for example, scratching or abrasion, it is not enough to hamper performance of the films or coatings disclosed herein.

“Porosity” is a measure of empty space in a material and can be expressed as a fraction of void volume over total volume. Having a high degree of porosity (i.e., a value close to 1 or a percentage close to 100%) indicates that a material has a high void volume. Porosity can increase based on number and density of pores as well as size of pores. In one aspect, a higher surface-area-to-volume ratio in a material can be achieved by having a large number of smaller pores. In some aspects, pores can be interconnected. In another aspect, the porosity of the disclosed films and coatings is optimized to allow passage of viral particles while minimizing diffusion time.

“Wettability” refers to the ability of a liquid to spread on and adhere to a solid surface and relates to intermolecular interactions between the solid surface and the fluid, as well as interactions within the fluid itself. In one aspect, the films and coatings disclosed herein are hydrophilic and thus wettable with water. Further in this aspect, wettability of the films and coatings allows for microbial particles in respiratory droplets to enter the interiors of the films and coatings and become inactivated. In one aspect, wettability can be evaluated using measurements such as, for example, contact angle.

As used herein, “diffusion time” refers to the amount of time it takes for a respiratory droplet and/or microbial particles contained therein to travel to the inactivation layers of the films and coatings disclosed herein. Diffusion time depends on surface geometry and void space geometry, but also depends on the distance traveled. In a further aspect, by optimizing pore size relative to virion size, diffusion time can be reduced from a period of hours or tens of hours to just a few minutes.

As used herein, “transparent” refers to a property of a material to transmit light without appreciable scattering and/or absorption so that objects on the other side of the transparent object can be seen clearly. Transparency does not require that 100% of light is transmitted through an object; some scattering or absorption can occur, but is sufficiently low such that a user can see through the object.

Unless otherwise specified, temperatures referred to herein are listed in ° C. and pressures are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Antimicrobial Films and Coatings

In one aspect, disclosed herein is an antimicrobial film including a metal or metal oxide and a matrix, wherein the metal or metal oxide contacts the matrix. In some aspects, the metal oxide is embedded in the matrix. In other aspects, the matrix has an outer surface and the metal or metal oxide contacts or protrudes from the exterior surface. In any of these aspects, the metal can be Ag, Cu, Zn, or any combination thereof, and the metal oxide can be CuO, Cu₂O, ZnO, MgO, TiO₂, Ag₂O, Fe₂O₃, Sb₂O₃, Al₂O₃, or any combination thereof. In some aspects, the metal or metal oxide can include particles. In one aspect, the particles can have an average diameter of about from about 0.5 μm to about 50 μm, or of about 0.5, 1, 5, 10, 15, 20, 25, 30, 35, 40, 45, or about 50 μm, or a combination of any of the foregoing values, or a range encompassing any of the foregoing values.

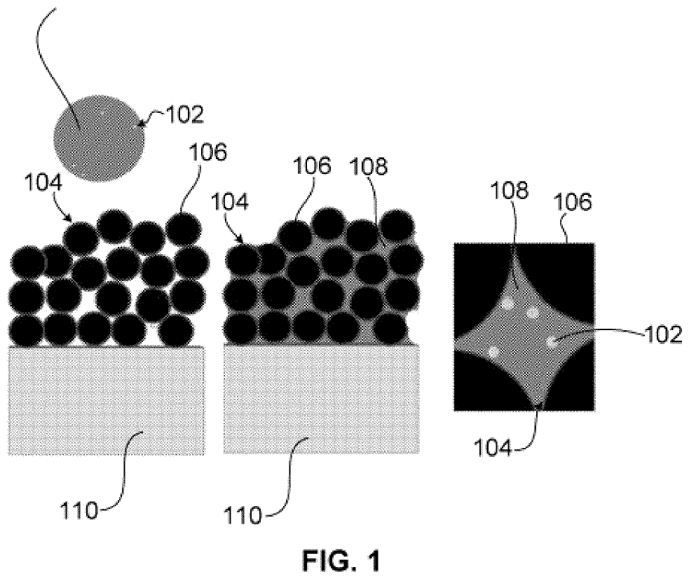

In one aspect, disclosed herein are porous, high-surface-area films with a thin inactivation layer (FIG. 1). In one exemplary aspect, a droplet 100 containing pathogenic organisms or particles 102 comes into contact with surface 110, wherein surface 110 has been treated with a virus- or microbe-inactivating coating or wrap consisting of particles 106 optionally coated with inactivation layer 104. When droplet 100 enters the coating or wrap, it is drawn into pores 108 in the coating, along with any pathogens 102, which are then inactivated. In some aspects, the inactivation layer can be hydrophobic. In other aspects, the inactivation layer is hydrophilic In a further aspect, when the inactivation layer is hydrophilic, the hydrophilic nature of the inactivation layer, as well as the high surface area to volume ratio, draws the microbe-containing liquid towards the porous interior of the film. In a further aspect, once inside the pores, the microbe has a much shorter distance to travel to the inactivating layer. Without wishing to be bound by theory, inactivating the inside of a coating with a high surface area:volume ratio decreases diffusion time and protects the microbe inactivation layer from abrasion. In a further aspect, the film can remain hydrophilic after at least four months of use. In some aspects, a droplet making contact with the antimicrobial film has a contact angle of less than about 10°, or of less than about 9°, or of less than about 8°, or of less than about 7°, or of less than about 6°, or of less than about 5°, or a combination of any of the foregoing values, or a range encompassing any of the foregoing values. In another aspect, at from about 0% to about 95% atmospheric humidity, a 5 μL droplet is completely imbibed into the film within about 80 seconds or less, optionally within about 60 seconds or less, within about 45 seconds or less, 30 seconds or less, about 15 seconds or less, or about 5 seconds or less. In another aspect, a thicker film results in faster imbibition of droplets as compared to a thinner film having the same composition and structure.

In another aspect, the coatings disclosed herein have both interior and exterior surfaces that inactivate viruses, bacteria, and fungi. In some aspects, the coatings disclosed herein can be combined with existing microbe-inactivating surfaces incorporating amine and ammonium polymers including quaternary ammonium polymers, metals and metal ions (e.g., copper, zinc, silver), metal oxides (e.g., Cu₂O, CuO, ZnO, Ag₂O), and combinations thereof.

In some aspects, porosity in the films can be generated with fibers, particles, by etching, or using another technique. In one aspect, the particles can be Cu₂O or other antimicrobial particles. In one aspect, the particles or fibers are intrinsically microbe-inactivating. In an alternative aspect, the particles or fibers are useful structurally for creating pores that can inactivate viruses, bacteria, and fungi. In any of these aspects, the films can include an additional inactivating layer. In one aspect, the inactivating layer can be added to the films after the pores are formed, or can be added to fibers, metal oxides, silica particles, silicate, or combinations thereof, or glass particles, prior to creation of the pores (e.g., by functionalization of the metal oxides, silica, silicate, glass, or fibers with amines or ammonium groups), or some combination thereof.

In one aspect, the coatings disclosed herein can inactivate viral particles in one hour or less. In one aspect, the antimicrobial film can inactivate at least 45% of viral particles that contact the film within about 1 minute, 80% of viral particles that contact the film within about 20 minutes, or can inactivate at least 99.8% of viral particles that contact the film within about 30 minutes, or can inactivate at least 99.9% of viral particles that contact the film within about 1 hour. In any of these aspects, the viral particles can be from a poxvirus, human papillomavirus, parvovirus, lassa virus, rotavirus, herpes simplex virus types 1 or 2, influenza virus, human immunodeficiency virus (HIV), human T cell leukemia virus (HTLV), Epstein-Barr virus (EBV), human cytomegalovirus (HCMV), Kaposi's sarcoma-associated herpesvirus (KSHV), varicella-zoster virus (VZV), hepatitis B virus, hepatitis C virus, Ebola virus, Marburg virus, parainfluenza virus, human respiratory syncitial virus, Hendra virus, Nipah virus, mumps virus, measles virus, hantavirus, bunyavirus, Rift Valley fever virus, sin nombre virus, rabies virus, an encephalitis virus, West Nile virus, yellow fever virus, Dengue virus, norovirus, rubella virus, Zika virus, severe acute respiratory syndrome virus (SARS-CoV), severe acute respiratory syndrome virus 2 (SARS-CoV-2), Middle East respiratory syndrome (MERS), another coronavirus, or any combination thereof.

In another aspect, the coatings disclosed herein can inactivate bacterial cells selected from Bacillus anthracis, Bacillus cereus, Bartonella henselae, Bartonella quintana, Bordetella pertussis, Borrelia burgdorferi, Borellia garinii, Borrelia afzelii, Borellia recurrentis, Brucella abortus, Brucella canis, Brucella melitensis, Brucella suis, Campylobacter jejuni, Chlamydia pneumonia, Chlamydia trachomatis, Chlamodyphila psittaci, Clostridium botulinum, Clostridium difficile, Clostridium perfringens, Clostridium tetani, Corynebacterium diphtheria, Enterococcus faecalis, Enterococcus faecium, Escherichia coli, Francisella tularensis, Haemophilus influenza, Helicobacter pylori, Legionella pneumophila, Leptospira interrogans, Leptospira santarosai, Leptospira weilii, Leptospira noguchii, Listeria monocytogenes, Mycobacterium leprae, Mycobacterium tuberculosis, Mycobacterium ulcerans, Mycoplasma pneumonia, Neisseria gonorrhoeae, Neisseria meningitides, Pseudomonas aeruginosa, Rickettsia rickettsii, Salmonella typhi, Salmonella typhimurium, Shigella sonnei, Staphylococcus aureus, Staphylococcus epidermidis, Staphylococcus saprophyticus, Streptococcus agalactiae, Streptococcus pneumonia, Streptococcus pyogenes, Treponema pallidum, Ureaplasma urealyticum, Vibrio cholera, Yersinia pestis, Yersinia enterocolitica, Yersinia pseudotuberculosis, other pathogenic bacteria, or any combination thereof. In an aspect, the disclosed films and coatings inactivate at least 99.99% of Pseudomonas aeruginosa cells that contact the films within 10 minutes, or at least 95% of Staphylococcus aureus cells that contact the films within 10 minutes, including, but not limited to, methicillin-resistant Staphylococcus aureus (MRSA).

In still another aspect, the disclosed films and coatings can inactivate fungal cells selected from Aspergillus fumigatus, Aspergillus niger, Blastomyces dermatitidis, Candida albicans, Candida auris, Candida glabrata, Candida parapsilosis, Coccidiodes immitis, Coccidioides posadasii, Cryptococcus neoformans, Cryptococcus gattii, Epidermophyton floccosum, Trichophyton interdigitale, Trichophyton mentagrophytes, Trichophyton rubrum, Trichophyton tonsurans, Histoplasma capsulatum, Rhizopus oryzae, Pneumocystis jirovecii, Sporotrichosis schenckii, Sporothrix brasiliensis, another pathogenic fungus, or any combination thereof.

In an aspect, disclosed herein is a surface including the antimicrobial films disclosed herein in conjunction with a substrate. In another aspect, the substrate can be transparent. In still another aspect, the substrate can be an acrylic surface, a polycarbonate surface, a glass surface, a sapphire surface, or any combination thereof.

In one aspect, disclosed herein is an antimicrobial film including an exterior surface and an interior surface, wherein the interior surface includes a plurality of pores in communication with the exterior surface. In another aspect, the film includes matrix particles, matrix fibers, or a combination thereof. In one aspect, the matrix particles can include glass, silica, silicate, or any combination thereof. In another aspect, the matrix fibers can include nanocellulose, metal wire, cellulose or a derivative thereof, chitin or a derivative thereof, wool, silk, cotton, flax, hemp, or any combination thereof. In a further aspect, the matrix includes a polymer and the particles are composed of a metal oxide. In still another aspect, the polymer can be polyethylene, polystyrene, polyvinylchloride, polydimethylsiloxane, a polyester, an acrylic, a nylon, an epoxy, a polyurethane, polymethylmethacrylate, fluorinated ethylene propylene, polytetrafluoroethylene, polypropylene, polyethylene, poly-oxydiphenylene-pyromellitimide, polyethylene terephthalate, a silicone, polyether ether ketone, polydopamine or a derivative thereof, or any combination thereof. In one aspect, the polydopamine derivative can be a polymer comprising monomer units selected from 3,4-dihydroxy-L-phenylalanine, norepinephrine, 2-bromo-N-[2-(3,4-dihydroxyphenyl)ethyl]-2-methyl propenamide, 6-nitrodopamine, or any combination thereof.

In another aspect, the metal oxide can be CuO, Cu₂O, ZnO, MgO, TiO₂, Ag₂O, Fe₂O₃, Sb₂O₃, Al₂O₃, or a combination thereof. In one aspect, the polymer is polyurethane and the metal oxide is Cu₂O. In one aspect, the polymer is polydopamine and the metal oxide is Cu₂O. In one aspect, the polymer is polydopamine and the metal is Cu. In some aspects, the matrix does not include a polymer. In one aspect, the matrix can be a silicate and the metal oxide can be Ag₂O. In another aspect, the metal oxide is CuO and no polymer is present. In any of these aspects, the pores are sufficiently wettable by the microbe-containing liquid that the liquid is able to infiltrate into the film. In one aspect, the film is hydrophobic. In another aspect, the film is hydrophilic. Without wishing to be bound by theory, polymers can contribute in various ways to the films disclosed herein such as, for example, by serving as binders for particles, as fibers useful for creating the porous structure of the films, or a combination thereof. In some exemplary aspects, polymers are not required for the construction of the films. Further in these aspects, metal oxide particles can be bound together by another means such as, for example, by sintering.

In one aspect, the film includes silica particles, silicate, amine groups or polymers, ammonium groups or polymers, or any combination thereof. In another aspect, the film has a thickness of from about 5 μm to about 100 μm, or from about 25 μm to about 35 μm, or about 5, 10, 15, 20, 25, 30, 35, 40, 45, 50, 55, 60, 65, 70, 75, 80, 85, 90, 95, or about 100 μm, or a combination of any of the foregoing values, or a range encompassing any of the foregoing values. In one aspect, the film is about 30 μm thick. In another aspect, the antimicrobial film can inactivate at least 80% of SARS-CoV-2 particles that contact the film within 20 minutes, or can inactivate at least 99.8% of SARS-CoV-2 particles that contact the film within about 30 minutes, or can inactivate at least 99.9% of SARS-CoV-2 particles that contact the film within about 1 hour. In another aspect, a thicker film can improve the imbibition and lower the infectivity significantly.

In any of these aspects, the antimicrobial films are recyclable.

### Pore Size

In one aspect, in the films disclosed herein, pore size in the films must be larger than the viruses, bacteria, and/or fungi to be inactivated to enable movement of the microbes through the pores. In another aspect, diffusion into the pores takes time. In a further aspect, diffusion may be suppressed by liquids and droplets having a greater viscosity such as might be seen with sneezes, coughs, saliva, and the like. In one aspect, smaller pores slow viscous flow into pores. Further in this aspect, larger pore sizes may equate to faster diffusion rates, but in another aspect, this must be balanced against considerations including surface area of contact for microbial particles against the inactivating film and other factors.

In a further aspect, SARS-CoV-2 is about 100 nm in diameter, so the pore diameter for inactivating this virus would need to be greater than 100 nm in size, with other sizes being possible for other viruses, bacteria, and/or fungi having different particle sizes. In another aspect, a larger pore size can lead to a longer diffusional time before the microbe strikes the inactivating surface, so the pores can be less than about 500 μm in diameter, or less than about 1000 μm in diameter. Thus, in one aspect, the pores are from about 100 nm to about 1000 μm in diameter, or about 2 to about 1000 μm in diameter, or are about 10 to about 50 μm in diameter, or are about 100, 200, 300, 400, 500, 600, 700, 800, or 900 nm, or about 1, 2, 5, 10, 15, 20, 25, 50, 100, 150, 200, 250, 300, 350, 400, 450, 500, 550, 600, 650, 700, 750, 800, 850, 900, 950, or about 1000 μm in diameter, or a combination of any of the foregoing values, or a range encompassing any of the foregoing values. In some aspects, the pore diameter for non-leaching films is at least 10 times the size of viral particles so that initial viral absorption does not block the pores. In one aspect, the inactivating layer has a finite width that should not clog the entire pore. In a further aspect, the pores are ideally as small as possible considering the above limitations. In any of these aspects, the pores in one film may be of different sizes.

In another aspect, the pores have a high degree of connectedness such that the microbial particles can access a large fraction of the interior surface. In one aspect, this feature decreases the time period over which the microbe can be inactivated.

In another aspect, the pore volume of the film is from about 50% to about 70% of total film volume, or from about 55% to about 65% of total film volume, or is about 50, 55, 60, 65, or about 70% of total film volume, or a combination of any of the foregoing values, or a range encompassing any of the foregoing values.

### Wettability

In another aspect, the microbe-inactivating films disclosed herein have suitable wettability such that liquids are drawn into the pores. Further in this aspect, good wettability allows for a higher contact area for the microbe to collide with surface walls. In some aspects, the films have hydrophilic surfaces such that water can be drawn into the pores. However, in other aspects, surface chemistry can be tuned for particular applications. In one aspect, the wettability of the films can be adjusted by any method known in the art including, but not limited to, treatment with plasma, ozone, light, oxidizing fluids, acids, or bases. In a further aspect, the wettability of the films can be adjusted by addition of wettability compounds in the microbe inactivation layer. In one aspect, the pores can be modified to include hydroxyl, ethoxy, zwitterionic, carboxylic, or amine chemical groups to improve wettability. In a further aspect, methods of introducing these chemical groups are known in the art and include via silanes, thiols, chelating groups that bind metals and metal oxides. polymers, surfactants, and combinations thereof.

In another aspect, the microbe-inactivating films disclosed here have suitable wettability and pore size such that the pores are not permanently filled with water that condenses from the atmosphere.

### Example Film Materials

In one aspect, a film as disclosed herein can be about 100 μm thick and can be constructed from Cu₂O particles about 5 μm in diameter, bonded together with polyurethane. In a further aspect, the film is treated with argon plasma to make the film hydrophilic and remove excess polyurethane. In a further aspect, the Cu₂O particles in films constructed in this manner inactivate SARS-CoV-2.

In another aspect, a film disclosed herein can be about 100 μm thick and can be constructed from silica, silicate, or a combination thereof, or glass particles bonded together with silica using, for example, the sol-gel method, or by sintering the particles together at an elevated temperature. In a further aspect, the surface of this film can be subsequently reacted with amine or ammonium polymers. Further in this aspect, the particles form a porous structure and are then coated with the inactivating layer disclosed herein.

In still another aspect, a film as disclosed herein can be about 5 μm thick and can be constructed from silica particles bonded together with silica using the sol-gel method, silicate, or any combination thereof. Further in this aspect, the surfaces of particles and the underlying material can be coated with an amine or ammonium polymer to inactivate viruses, bacteria, and/or fungi.

In one aspect, a film as disclosed herein can be more than about 30 μm thick and can be constructed from CuO particles, where the CuO particles are sintered together from a Cu₂O starting material.

In one aspect, a film as disclosed herein can be a layer of fibers that intrinsically inactivate the microbe or wherein the fibers have modified chemistry that inactivates the microbe or wherein the fibers are decorated with particles that inactivate the microbe.

In one aspect, the films can include metal or metal oxide particles or nanoparticles on a thin film of polydopamine. In some aspects, metal oxide particles can be grown or formed on a thin layer of polydopamine. In one aspect, metal nanoparticles can be grown on the polydopamine and oxidized to metal oxide nanoparticles. In one aspect, electroless deposition of metal from metal ions can be performed. In one aspect, the metal particles can be nanoparticles. Further in this aspect, nanoparticles scatter light less than larger particles, resulting in less distortion of appearance of objects beneath the films and coating.

### Appearance of the Films

In one aspect, the films disclosed herein, when incorporating Cu₂O, can have a reddish appearance. In another aspect, individuals may be reluctant to touch a reddish surface, or a reddish surface may be aesthetically unpleasing. Further in this aspect, alternative films can be used that incorporate CuO. In one aspect, CuO films can be gray in color. In another aspect, gray films may be more suitable for high-touch surfaces such as, for example, door handles, railings, and the like.

In one aspect, ingredients for inactivating microbes can be opaque in some circumstances, and may decrease the transparency of films and/or coatings. In one aspect, factors such as, for example, density of particles, size of particles, thickness of coating, and/or refractive index mismatch of matrix material relative to the particles can be modified to reduce loss of transparency. In one aspect, the active antimicrobial ingredients can be present at the surface of antimicrobial films and coatings, or can be provided on a porous matrix such that ions, molecules, microbes, and virus particles can penetrate the matrix.

In some aspects, the films and coatings can be transparent. In one aspect, a transparent coating or film can be particularly important where the object to be coated is a display or touch screen such as, for example, a smartphone, computer, tablet, payment station at a retailer, vending machine, machinery control station, check-in facility for travel, or a commonly touched public surface such as a door handle, railing, interior transportation surface, reception area, hospital bed rails, toilet seat, flush valve for a toilet, tap handles, light switches, elevator buttons, plexiglass dividers, mirrors, and the like. In another aspect, transparent coatings and films can help preserve the appearance and aesthetic appeal of other surfaces including, but not limited to, wood, metals, granite, surfaces incorporating business color schemes, and the like. In one aspect, metal nanoparticles on a polydopamine polymer support can result in the formation of a transparent film.

### Durability of the Films and Coatings

In an aspect, the disclosed films and coatings have wear resistance and remain intact and functional for at least a period of days, weeks, or months under everyday use.

### Application of the Films and Coatings

In one aspect, the coatings disclosed herein can be sprayable. In another aspect, the coatings can be prepared rapidly and from inexpensive ingredients. In one aspect, the sprayable coatings can be applied to glass, plastic, wood, steel, galvanized metals, ceramic, stone, and other common surfaces. In one exemplary aspect, polyurethane, acetone, and Cu₂O can be mixed to make a sprayable coating. In another aspect, a 0.2% (w/w) mixture of Cu₂O particles in Tris buffer can be sonicated to form a suspension, followed by addition of dopamine hydrochloride to a final concentration of 0.05 g. In another aspect, spray-coating can be accomplished in multiple steps such as, for example, a first spray coating of polyurethane diluted with acetone is applied to a surface followed by a second spray coating of a 25% (w/w) solution of Cu₂O in ethanol.

In one aspect, the antimicrobial coatings disclosed herein can be disposed on adhesive-backed films, including plastic films, or can be formulated to include adhesives. In one aspect, the antimicrobial films can be used in places where deployment of sprayable coatings may not be practical, such as, for example, in high-traffic public spaces. Further in this aspect, application of the films and/or wraps can eliminate the need for personal protective equipment such as, for example, masks and respirators, while applying the films. In one aspect, the films can be formulated as antimicrobial wraps for surfaces having various shapes such as, for example, door handles, rails, desks, tables, toilet seats, walls, and the like. In another aspect, the adhesive-backed films can be peeled off surfaces when worn or when no longer needed, thus restoring the original, undamaged surfaces. In one aspect, the films can have a protective surface over the adhesive prior to attaching the films to a surface, and/or can have a protective surface over the antimicrobial coatings on the films to protect the films prior to use.

In any of these aspects, following removal of the films, the films and active ingredients can be recycled, thus reducing waste.

In one aspect, the films are flexible, thereby allowing the films to be applied to existing articles having curves, bends, and/or contours that are not perfectly flat.

### Wraps, Fibers, and Fabrics Incorporating Antimicrobial Coatings

In one aspect, disclosed herein are wraps, fibers, and fabrics incorporating antimicrobial coatings as disclosed herein. In a further aspect, metal or metal oxides can be generated in situ on the wraps, fibers, and fabrics, or can be bonded to the surfaces of the wraps, fibers, and fabrics, or active metal oxides can be bloomed on the surfaces of the wraps, fibers, and fabrics as they are formed.

In another aspect, the fibers are generated as individual active antimicrobial fibers and woven or bonded into cloth or sheets. In an alternative aspect, antimicrobial activity can be imparted after formation of cloth or sheets. In another aspect, antimicrobial fibers, cloth, and sheets can be utilized in a variety of ways such as, for example, commercial air filters, home air filters, and transportation cabin air filters, or in clothing, carpet, upholstery, automotive door panels, transportation seating, and the like. In still another aspect, the antimicrobial cloth and sheets can be recycled, preventing the active ingredients from entering the environment.

In some aspects, the wraps, fibers, and fabrics can be porous. In one aspect, porous wraps and fabrics visually appear to be flat but contain pores into which infectious droplets can rapidly penetrate as disclosed herein, thus increasing antimicrobial activity.

In any of these aspects, when the wraps, fibers, or fabrics contain a polymeric component, the polymeric component can be or include polyurethane, polyester, fluorinated ethylene propylene (FEP), polyethylene, polyvinyl chloride, nylon, polytetrafluoroethylene (PTFE), poly-oxydiphenylene-pyromellitimide, polyether ether ketone (PEEK), a silicone polymer, or any combination thereof.

In one aspect, the disclosed fibers can be used to prepare articles such as carpets, furniture and upholstery, apparel, and personal protective equipment including, but not limited to, face masks, lab coats, and other articles of protective clothing.

### Exemplary Embodiments

Provided herein are non-limiting exemplary embodiments for antimicrobial wraps, fibers, and fabrics as disclosed herein. In one aspect, provided herein is a free-standing polymer wrap such as, for example, a polyurethane wrap. In a further aspect, the wrap can be purchased or fabricated in situ and modified by the deposition of a metal such as, for example, copper, zinc, or silver, followed by oxidation to produce the metal oxide. In one aspect, a thin surface layer of copper can be deposited and bonded onto a self-supporting urethane film through vapor deposition, chemical vapor deposition, or electroless deposition of copper. Further in this aspect, the deposited metal can be fully oxidized to produce an antimicrobial layer. In an alternative aspect, copper oxide or another metal oxide can be formed by the reduction of a deposited precursor.

In a second exemplary embodiment, a free-standing polymer wrap such as, for example, a polyurethane wrap, can be purchased or fabricated and modified by deposition of a metal oxide antimicrobial particle such as, for example, Cu₂O, CuO, ZnO, Ag₂O, or the like. In one aspect, a suspension of particles can be deposited on the film and the solvent can be allowed to evaporate.

In a further aspect, the wrap can be softened by heating near or above the glass transition temperature of the polymeric component of the wrap, holding the particles to the wrap by the large contact area produced by the softening of the polymer. In some aspects, adhesion or coupling agents (e.g., silanes, trimethylolpropane derivatives, epoxides) can be added to the particles or wrap prior to deposition to assist in adhesion. In an alternative aspect, the wrap can be softened by application of a solvent instead of or in addition to heating.

In a third exemplary embodiment, a plastic wrap with adhesive backing or a free-standing rap such as, for example, a polyurethane wrap, can be modified by spraying or painting a suspension of a metal oxide in a solvent on the wrap. In one aspect, a solid can be painted with polyurethane, allowed to partially cure, and then coated with Cu₂O suspended in ethanol. In some aspects, the solid can be a wrap such as disclosed herein, or the wrap could be applied to the solid and coating with metal oxide could commence. In certain aspects, when the wrap does not include adhesive, the wrap can be pretreated with a coupling agent to enhance adhesion.

In various aspects, a suspension of particles of an active ingredient and polymers in a solvent could be used to coat a wrap, wherein the polymers can form a film on top of the wrap to hold the active ingredient particles to the wrap. In another aspect, a suspension of particles of the active ingredient and monomers in a solvent could be used to coat a wrap. Further in this aspect, polymerization of the monomers can form a layer of particles in polymer, wherein the polymer holds the particles to the wrap. In any of these aspect, adhesive agents as disclosed herein can be added to the suspension of particles in a solvent to enhance adhesion of the polymer to the particles and/or the wrap.

### Methods for Making the Films

In one aspect, disclosed herein is a method for making an antimicrobial film, the method including the steps of (a) contacting a substrate with particles, fibers, or a combination thereof; and (b) binding the particles, fibers, or particles and fibers together to create the film. In another aspect, step (b) can be accomplished using a polymer binder, heat treatment (including sintering), sol-gel treatment, a chemical treatment, light activation, or a combination thereof. In one aspect, the substrate can be contacted with both particles and fibers. In another aspect, the fibers can be polyurethane and the particles can be Cu₂O.

In another aspect, sol-gel treatment can be accomplished using tetraethyl orthosilicate, zinc acetate, a derivative thereof, of a combination thereof.

In one aspect, step (b) is accomplished using heat treatment. In a further aspect, the heat treatment can be carried out using an initial ramp to a final temperature of from about 80° C. to about 200° C., or of about 80, 90, 100, 110, 120, 130, 140, 150, 160, 170, 180, 190, or about 200° C., or a combination of any of the foregoing values, or a range encompassing any of the foregoing values, followed by holding at the final temperature for a first period of time. In some aspects, the first period of time can be from about 1 hour to about 2 hours, or can be about 1, 1.25, 1.5, 1.75, or about 2 hours, or a combination of any of the foregoing values, or a range encompassing any of the foregoing values. In another aspect, following holding the substrate at 700° C. for the first period of time, the substrate can be allowed to cool to room temperature. In one aspect, without wishing to be bound by theory, the initial temperature ramp can be useful for preventing cracks in the substrate or the film during the heating step. In some aspects, the heat treatment can produce a higher oxidation state of a metal. For example, in one aspect, the particles can be Cu₂O and heat treatment can cause oxidation to CuO. Further in this aspect, the heat treatment can cause the CuO to sinter.

In one aspect, the method further includes coating the substrate with a solution of a polymer and drying the substrate prior to step (a). In some aspects, contacting the substrate with particles can include applying a suspension of a metal oxide in a solvent to the substrate and allowing the solvent to dry. In a further aspect, the method can also include (c) optionally heating the substrate and (d) treating the substrate with argon plasma. In one aspect, the polymer can be polyurethane, the metal oxide can be Cu₂O, and the solvent can be ethanol. In an alternative aspect, the particles can be silica, silicate, glass, or a combination thereof. In one aspect, when the particles are silica, silicate, glass, or a combination thereof, step (b) can be accomplished using sol-gel treatment or heat treatment (i.e., sintering). In a further aspect, the silica, silicate, and/or glass particles can include amine groups or polymers, ammonium groups or polymers, or a combination thereof.

In any of these aspects, following film formation, a stream of gas can be blown over the film to remove unbound materials. In a further aspect, the gas can be argon, nitrogen, air, or a combination thereof.

In an alternative aspect, provided herein is a method for making an antimicrobial film, the method including the steps of (a) admixing a film precursor and a metal or metal oxide in a solvent to form a first mixture; (b) depositing the first mixture on a substrate; and (c) evaporating the solvent from the first mixture to form the antimicrobial film. In some aspects, the film precursor includes one or more polymerizable monomers and the method further includes polymerizing the monomers. In an aspect, initiation of polymerization occurs upon admixture formation in step (a), over time, at elevated temperature, due to evaporation of a solvent, upon exposure to light, or any combination thereof. In another aspect, the film precursor can include one or more polymers. In one aspect, the film precursor can be dopamine hydrochloride and the antimicrobial film can be a polydopamine film. In another aspect, the metal or metal oxide can be Ag, Cu, Zn, CuO, Cu₂O, ZnO, MgO, TiO₂, Ag₂O, Fe₂O₃, Sb₂O₃, Al₂O₃, or any combination thereof. In any of these aspects, depositing the first mixture on the substrate can be accomplished by spraying the first mixture on the substrate, drop casting the first mixture on the substrate, immersing the substrate in the first mixture, or any combination thereof. In some aspects, drying the first mixture on the substrate can include drying in an oven, blowing a gas over the first mixture on the substrate, or a combination thereof. In another aspect, the substrate can be glass, a fiber, a textile, wood, tile, acrylic, metal, concrete, veneer, or any combination thereof. In one aspect, when the substrate is a fiber, the fiber can subsequently be formed into a textile, and the textile can be a knitted textile, a woven textile, a nonwoven textile, or any combination thereof. In one aspect, the nonwoven textile can be a meltblown textile.

In one aspect, the metal or metal oxide particles can be fully or partially dissolved and precipitated prior to forming the films. Without wishing to be bound by theory, dissolution and precipitation can contribute changes to the morphology of the metal or metal oxide particles, thereby altering the metal or metal oxide component of the films.

In still another aspect, disclosed herein is a method for making an antimicrobial film, the method including the steps of (a) coating a substrate with a film precursor; (b) drying the film precursor on the substrate to form a coated substrate; and (c) contacting the coated substrate with a solution including metal ions. In one aspect, the film precursor can include one or more polymerizable monomers and drying the first mixture on the substrate further includes polymerizing the monomers. In one aspect, the film precursor can be dopamine hydrochloride and the antimicrobial film can be a polydopamine film. In some aspects, the method further includes softening the film precursor on the coated substrate following step (b) to enhance adhesion of metal ions to the substrate. In one aspect, softening the film precursor is accomplished by heating above a glass transition temperature of the film precursor, contacting the film precursor with a solvent, or any combination thereof. In another aspect, the metal ions can be Ag ions, Cu ions, Zn ions, Mg ions, Ti ions, Fe ions, Sb ions, Al ions, or any combination thereof. In still another aspect, following step (c), the method further includes rinsing the coated substrate, drying the coated substrate, or both. In any of these aspects, the substrate can be or include glass, a fiber, a textile, wood, tile, acrylic, metal, concrete, veneer, or any combination thereof. In one aspect, when the substrate includes a fiber, a textile can be formed from the fiber including, but not limited to, a knitted textile, a nonwoven textile, a woven textile, or any combination thereof. In one aspect, the nonwoven textile can be a meltblown textile. An exemplary meltblown fibrous coating is shown in FIG. 18.

In yet another aspect, disclosed herein is a method for making an antimicrobial film, the method including the steps of (a) depositing a surface layer of a metal or metal particles on a substrate; and (b) oxidizing or reducing the metal or metal particles. In one aspect, depositing the surface layer of the metal can include physical vapor deposition, chemical vapor deposition, electroless deposition, or any combination thereof. In one aspect, the metal or metal particles can be selected from Ag, Cu, Zn, Mg, Ti, Fe, Sb, Al, or any combination thereof. In one aspect, reducing the metal or metal particles includes contacting the metal or metal particles with a reducing agent. In a further aspect, the reducing agent can be dimethylamine borane. In still another aspect, the substrate can be selected from glass, a fiber, a textile, wood, tile, acrylic, metal, concrete, veneer, a polymer film, or any combination thereof. In one aspect, when the substrate includes a synthetic fiber or a polymer film, the method can further include softening the synthetic fiber or the polymer film following step (a) to enhance adhesion of the metal or metal particles to the substrate. Further in this aspect, softening the synthetic fiber or the polymer film is accomplished by heating above a glass transition temperature of the synthetic fiber or the polymer film, contacting the synthetic fiber or the polymer film with a solvent, or any combination thereof. In some aspects, a coupling agent can be applied to the metal, metal particles, or substrate prior to step (a) to enhance adhesion of the metal or metal particles to the substrate. In one aspect, the coupling agent can be selected from a silane, a trimethylolpropane derivative, an epoxide, or any combination thereof. In some aspects, when the substrate includes a fiber, the method further includes forming a textile from the fiber. Further in this aspect, the textile can be a knitted textile, a woven textile, a nonwoven textile, or any combination thereof. In one aspect, the nonwoven textile can be a meltblown textile.

In another aspect, provided herein is a method for making an antimicrobial film, the method including the steps of (a) contacting a substrate with a solution including metal or metal particles; and (b) softening the substrate to enhance adhesion of the metal particles. In some aspects, the substrate can be a fibrous mat or textile. In still another aspect, softening the substrate can include heating above a glass transition temperature of the substrate, contacting the substrate with a solvent, or any combination thereof. In one aspect, the metal or metal particles can include Ag, Cu, Zn, Mg, Ti, Fe, Sb, Al, or any combination thereof.

In still another aspect, disclosed herein is a method for making an antimicrobial film, the method including the steps of (a) contacting a substrate having a plurality of pores with a polymer, wherein the polymer enters at least a portion of the plurality of pores, forming a porous polymer coating; and (b) depositing a metal or metal oxide on the porous polymer coating. In another aspect, the polymer can be dissolved in a solvent. In one aspect, the solvent can be acetone, water, or any combination thereof. In one aspect, the polymer can be polydopamine, polymethylmethacrylate (PMMA), or any combination thereof. In one aspect, the metal or metal oxide is deposited using electroless deposition.

In one aspect, the substrate can include a backing material and, optionally, an adhesive. Further in this aspect, removing the backing material enables application of the antimicrobial film to an existing article. In one aspect, the antimicrobial film can be removed from an existing article after a period of use. Further in this aspect, removal of the antimicrobial film restores the original surface of the article.

In an alternative aspect, the substrate can be an article to be coated directly with the antimicrobial film, or to be synthesized such that the antimicrobial film is an integral part of the substrate (e.g., a screen protector for a touch screen device).

Also disclosed are articles including antimicrobial films made by the disclosed methods. In a further aspect, the article can be a light switch, a door handle, a faucet handle, a railing, a piece of medical equipment, a bed rail, a cooking or food preparation surface, a surface in a retail store, a mass transit vehicle surface, an automobile surface, a hospital surface, a smartphone, a tablet computer, a cover for a personal electronic device, a computer mouse, a keyboard, a touch-screen, a screen protector for a touch-screen, a retail check-out facility or device, furniture, carpet, upholstery, equipment or machinery control surfaces, food packaging, athletic equipment, toilet seats, toilet flushing handles, communal religious articles, a packaging material, personal protective equipment, a filter, an article of apparel, an elevator button, a mirror, an acrylic divider, a polycarbonate surface, a sapphire surface, or any combination thereof, or any other surface where an antimicrobial coating would be desired. In one aspect, the personal protective equipment can be a lab coat or a face mask. In another aspect, the filter can be an air purification filter such as an air purification filter useful in a heating and air-conditioning system in a building.

### Mechanism of Action of the Films

In one aspect, the films and coatings disclosed herein should have surface coatings that spontaneously draw microbe-containing fluid to interior surfaces, such that the microbe contacts the interior surface of the films and coatings. In another aspect, the inactivating coatings disclosed herein appears on the inside of the films, as well as on the outside. In another aspect, drawing the virus particles to the interior of the films accomplishes several goals.

In one aspect, drawing the microbe to the interior reduces diffusion time. Without wishing to be bound by theory, inactivation relies on close contact between the inactivation layer and the microbe. Further in this aspect, in the absence of a driven flow, the microbe must either diffuse to the inactivation layer or, alternatively, the molecules from the inactivation layer need to diffuse to the microbe. In one aspect, by drawing the microbe into a porous structure, the distance between the microbe and inactivation layer is reduced.

In one aspect, diffusion depends on geometry of the surfaces and particles involved, but in another aspect, diffusion time depends approximately on the square of the distance traveled. In one aspect, a typical sneeze droplet is about 20 μL and has dimensions on the order of about 1 mm for a spherical or hemispherical droplet. Thus, in this aspect, the diffusion distance is on the order of about 0.5 mm. If this droplet is drawn into a pore that is about 50 μm in size, in one aspect, the diffusion distance can be reduced to about 25 μm and the diffusion time is reduced by a factor of about 400. In another aspect, by comparison, for a 100 nm virus, diffusion time can be reduced from tens of hours to a few minutes, and in another aspect, smaller pores can make diffusion even faster.

In another aspect, in the films and coatings disclosed herein, the surface area of the inactivation layer can be much larger in a porous film since all the inside area can also inactivate the microbe. In one aspect, the surface area of the inactivation layer scales with the square of the typical dimension. Thus, further in this aspect, by shrinking the dimension of the porosity, a greater surface area of inactivation layer is gained.

In one aspect, without wishing to be bound by theory, SARS-CoV-2 spike proteins have a net charge of about +3.5 at pH 7.4, while CuO from some exemplary embodiments has a negative zeta potential, and viral inactivation may occur due to electrostatic interaction of the spike proteins and the antimicrobial films.

In still another aspect, the films and coatings disclosed herein are robust. Without wishing to be bound by theory, if the inactivation layer was only on the outside of the coating, it would be subject to abrasion and might lose effectiveness overtime. In one aspect, if the inactivation layer is also on the interior of the coating, then abrasion of surface layers will not cause loss of the majority of the inactivation layer.

### Applications of the Films

The films disclosed herein are useful in a variety of settings. In one aspect, the films disclosed herein can be used in medical settings. In a further aspect, hospital bed rails, light switches, equipment switches, faucet handles, and other items could be coated with the inactivating films disclosed herein.

In another aspect, the films disclosed herein can be used in commercial settings, including, but not limited to, surfaces on construction materials and construction equipment, vehicle surfaces, transportation surfaces including those in mass transit vehicles and aircraft, door handles, shopping carts and baskets, shelving in stores, restaurant tables and seating, commercial kitchen surfaces, surfaces in grooming and personal care businesses, credit card payment equipment, machinery control buttons and knobs and surfaces, and the like.

In still another aspect, the films disclosed herein can be used in residential settings including, but not limited to, doorknobs, furniture, kitchen counters, faucets, toilet handles, showers and bathtubs, computers and electronic equipment, as well as military equipment and surfaces in cruise ships, sports stadiums, amusement parks, theaters, hotels, smartphones and tablets and their covers, and the like.

In another aspect, if there is a concern that a liquid contains microbial particles, the liquid could be pumped through a porous plug that is coated with the films disclosed herein to inactivate microbial particles that are contained in the liquid.

In one aspect, the antimicrobial films are resisting to debonding from substrates or surfaces to which they are applied. In a further aspect, resistance to debonding can be measured using a standard test method such as, for example, ASTM D3359 method B. In one aspect, the antimicrobial films are resistant to debonding even in the presence of a disinfecting agent such as, for example, ethanol (e.g., a roughly 70% ethanol solution) or bleach (e.g., a roughly 3% sodium hypochlorite solution).

### Aspects

The present disclosure can be described in accordance with the following numbered Aspects, which should not be confused with the claims.

Aspect 1. An antimicrobial film comprising a metal or metal oxide and a matrix, wherein the metal or metal oxide contacts the matrix.

Aspect 2. The antimicrobial film of aspect 1, wherein the metal or metal oxide is embedded in the matrix.

Aspect 3. The antimicrobial film of aspect 1 or 2, wherein the matrix comprises an exterior surface and wherein the metal or metal oxide contacts or protrudes from the exterior surface.

Aspect 4. The antimicrobial film of any one of aspects 1-3, wherein the metal comprises Ag, Cu, Zn, or any combination thereof.

Aspect 5. The antimicrobial film of any one of aspects 1-3, wherein the metal oxide comprises CuO, Cu₂O, ZnO, MgO, TiO₂, Ag₂O, Fe₂O₃, Sb₂O₃, Al₂O₃, or any combination thereof.

Aspect 6. The antimicrobial film of any one of the preceding aspects, wherein the metal or metal oxide comprises particles.

Aspect 7. The antimicrobial film of aspect 6, wherein the particles have an average diameter in at least one dimension of from about 0.5 μm to about 50 μm.

Aspect 8. The antimicrobial film of any one of the preceding aspects, wherein the matrix comprises an exterior surface and an interior surface, and wherein the interior surface comprises a plurality of pores in communication with the exterior surface.

Aspect 9. The antimicrobial film of any one of the preceding aspects, wherein the matrix comprises matrix particles, matrix fibers, or any combination thereof.

Aspect 10. The antimicrobial film of aspect 9, wherein the matrix particles comprise glass, silica, silicate, or any combination thereof.

Aspect 11. The antimicrobial film of aspect 9, wherein the matrix fibers comprise nanocellulose, metal wire, cellulose or a derivative thereof, chitin or a derivative thereof, wool, silk, cotton, flax, hemp, or any combination thereof.

Aspect 12. The antimicrobial film of any one of the preceding aspects, wherein the matrix comprises a polymer.

Aspect 13. The antimicrobial film of aspect 12, wherein the polymer comprises polyethylene, polystyrene, polyvinylchloride, polydimethylsiloxane, a polyester, an acrylic, a nylon, an epoxy, a polyurethane, polymethylmethacrylate, fluorinated ethylene propylene, polytetrafluoroethylene, polypropylene, polyethylene, poly-oxydiphenylene-pyromellitimide, polyethylene terephthalate, a silicone, polyether ether ketone, polydopamine or a derivative thereof, or any combination thereof.

Aspect 14. The antimicrobial film of aspect 13, wherein the polydopamine derivative comprises a polymer comprising monomer units selected from 3,4-dihydroxy-L-phenylalanine, norepinephrine, 2-bromo-N-[2-(3,4-dihydroxyphenyl)ethyl]-2-methyl propenamide, 6-nitrodopamine, or any combination thereof.

Aspect 15. The antimicrobial film of aspect 13, wherein the polymer comprises polyurethane and the metal oxide comprises Cu₂O.

Aspect 16. The antimicrobial film of aspect 13, wherein the polymer comprises polydopamine and the metal oxide comprises Cu₂O.

Aspect 17. The antimicrobial film of aspect 13, wherein the polymer comprises polydopamine and the metal oxide comprises Ag₂O.

Aspect 18. The antimicrobial film of aspect 13, wherein the polymer comprises dopamine and the metal comprises Cu.

Aspect 19. The antimicrobial film of aspect 13, wherein the polymer comprises polydopamine and the metal oxide comprises Cu₂O.

Aspect 20. The antimicrobial film of aspect 13, wherein the polymer comprises polydopamine and the metal comprises Cu.

Aspect 21. The antimicrobial film of aspect 13, wherein the polymer comprises polydopamine and the metal comprises Ag.

Aspect 22. The antimicrobial film of any one of the preceding aspects, wherein the matrix does not include a polymer.

Aspect 23. The antimicrobial film of aspect 22, wherein the matrix comprises silica, silicate, or any combination thereof, and the metal oxide comprises Ag₂O.

Aspect 24. The antimicrobial film of any one of the preceding aspects, wherein the film is hydrophobic.

Aspect 25. The antimicrobial film of any one of the preceding aspects, wherein the film is hydrophilic.

Aspect 26. The antimicrobial film of aspect 25, wherein the film remains hydrophilic after at least four months of use.

Aspect 27. The antimicrobial film of aspect 25 or 26, wherein a droplet making contact with the antimicrobial film has a contact angle of less than about 10°.

Aspect 28. The antimicrobial film of any one of aspects 25-27, wherein at from about 0% to about 95% atmospheric humidity, a 5 μL droplet is completely imbibed into the film within about 80 seconds or less.

Aspect 29. The antimicrobial film of any one of the preceding aspects, wherein the film further comprises amine polymers, ammonium polymers, or any combination thereof.

Aspect 30. The antimicrobial film of any one of the preceding aspects, wherein the film has a thickness of from about 5 μm to about 100 μm.

Aspect 31. The antimicrobial film of any one of the preceding aspects, wherein the film has a thickness of from about 25 μm to about 35 μm.

Aspect 32. The antimicrobial film of any one of the preceding aspects, wherein the pores have an average diameter of from about 1 μm to about 50 μm.

Aspect 33. The antimicrobial film of any one of aspects 1-31, wherein the pores have an average diameter of from about 10 μm to about 50 μm.

Aspect 34. The antimicrobial film of any one of the preceding aspects, comprising a pore volume of from about 50% to about 70% of total film volume.

Aspect 35. The antimicrobial film of any one of the preceding aspects, comprising a pore volume of about 55% to about 65% of total film volume.

Aspect 36. The antimicrobial film of any one of the preceding aspects, further comprising an adhesive.

Aspect 37. The antimicrobial film of any one of the preceding aspects, wherein the antimicrobial film inactivates at least one virus, bacterium, or fungus that contacts the film.

Aspect 38. The antimicrobial film of aspect 37, wherein the at least one virus comprises a poxvirus, human papillomavirus, parvovirus, lassa virus, rotavirus, herpes simplex virus types 1 or 2, influenza virus, human immunodeficiency virus (HIV), human T cell leukemia virus (HTLV), Epstein-Barr virus (EBV), human cytomegalovirus (HCMV), Kaposi's sarcoma-associated herpesvirus (KSHV), varicella-zoster virus (VZV), hepatitis B virus, hepatitis C virus, Ebola virus, Marburg virus, parainfluenza virus, human respiratory syncitial virus, Hendra virus, Nipah virus, mumps virus, measles virus, hantavirus, bunyavirus, Rift Valley fever virus, sin nombre virus, rabies virus, an encephalitis virus, West Nile virus, yellow fever virus, Dengue virus, norovirus, rubella virus, Zika virus, severe acute respiratory syndrome virus (SARS-CoV), severe acute respiratory syndrome virus 2 (SARS-CoV-2), Middle East respiratory syndrome (MERS), another coronavirus, or any combination thereof.

Aspect 39. The antimicrobial film of aspect 38, wherein the antimicrobial film inactivates at least 45% of SARS-CoV-2 particles that contact the film within 1 minute.

Aspect 40. The antimicrobial film of aspect 38, wherein the antimicrobial film inactivates at least 80% of SARS-CoV-2 particles that contact the film within 20 minutes.

Aspect 41. The antimicrobial film of aspect 38, wherein the antimicrobial film inactivates at least 99.8% of SARS-CoV-2 particles that contact the film within 30 minutes.

Aspect 42. The antimicrobial film of aspect 38, wherein the antimicrobial film inactivates at least 99.9% of SARS-CoV-2 particles that contact the film within 1 hour.

Aspect 43. The antimicrobial film of aspect 37, wherein the at least one bacterium comprises Bacillus anthracis, Bacillus cereus, Bartonella henselae, Bartonella quintana, Bordetella pertussis, Borrelia burgdorferi, Borellia garinii, Borrelia afzelii, Borellia recurrentis, Brucella abortus, Brucella canis, Brucella melitensis, Brucella suis, Campylobacter jejuni, Chlamydia pneumonia, Chlamydia trachomatis, Chlamodyphila psittaci, Clostridium botulinum, Clostridium difficile, Clostridium perfringens, Clostridium tetani, Corynebacterium diphtheria, Enterococcus faecalis, Enterococcus faecium, Escherichia coli, Francisella tularensis, Haemophilus influenza, Helicobacter pylori, Legionella pneumophila, Leptospira interrogans, Leptospira santarosai, Leptospira weilii, Leptospira noguchii, Listeria monocytogenes, Mycobacterium leprae, Mycobacterium tuberculosis, Mycobacterium ulcerans, Mycoplasma pneumonia, Neisseria gonorrhoeae, Neisseria meningitides, Pseudomonas aeruginosa, Rickettsia rickettsii, Salmonella typhi, Salmonella typhimurium, Shigella sonnei, Staphylococcus aureus, Staphylococcus epidermidis, Staphylococcus saprophyticus, Streptococcus agalactiae, Streptococcus pneumonia, Streptococcus pyogenes, Treponema pallidum, Ureaplasma urealyticum, Vibrio cholera, Yersinia pestis, Yersinia enterocolitica, Yersinia pseudotuberculosis, or any combination thereof.

Aspect 44. The antimicrobial film of aspect 43, wherein the antimicrobial film inactivates at least 99.99% of Pseudomonas aeruginosa cells that contact the film within 10 minutes.

Aspect 45. The antimicrobial film of aspect 43, wherein the antimicrobial film inactivates at least 96% of Staphylococcus aureus cells that contact the film within 10 minutes.

Aspect 46. The antimicrobial film of aspect 37, wherein the at least one fungus comprises Aspergillus fumigatus, Aspergillus niger, Blastomyces dermatitidis, Candida albicans, Candida auris, Candida glabrata, Candida parapsilosis, Coccidiodes immitis, Coccidioides posadasii, Cryptococcus neoformans, Cryptococcus gattii, Epidermophyton floccosum, Trichophyton interdigitale, Trichophyton mentagrophytes, Trichophyton rubrum, Trichophyton tonsurans, Histoplasma capsulatum, Rhizopus oryzae, Pneumocystis jirovecii, Sporotrichosis schenckii, Sporothrix brasiliensis, or any combination thereof.

Aspect 47. The antimicrobial film of any one of the preceding aspects, wherein the antimicrobial film is recyclable.

Aspect 48. A surface comprising the antimicrobial film of any one of the preceding aspects and a substrate.

Aspect 49. The surface of aspect 48, wherein the substrate is transparent.

Aspect 50. The surface of aspect 48 or 49, wherein the substrate comprises an acrylic surface, a polycarbonate surface, a glass surface, a sapphire surface, or any combination thereof.

Aspect 51. A method for making an antimicrobial film, the method comprising:
(a) contacting a substrate with particles, fibers, or any combination thereof; and
(b) binding the particles, fibers, or particles and fibers together to create the film.

Aspect 52. The method of aspect 51, wherein, in step (a), the substrate is contacted with both particles and fibers.

Aspect 53. The method of claim 52, wherein the fibers comprise polyurethane and the particles comprise Cu₂O.

Aspect 54. The method of any one of aspects 51-53, wherein step (b) is accomplished using a polymer binder, heat treatment, sol-gel treatment, a chemical treatment, light activation, or any combination thereof.

Aspect 55. The method of aspect 54, wherein sol-gel treatment is accomplished using tetraethyl orthosilicate, zinc acetate, a derivative thereof, or a combination thereof.

Aspect 56. The method of aspect 51, wherein the particles comprise tetraethyl orthosilicate and Ag₂O or Ag.

Aspect 57. The method of aspect 51, wherein step (b) is accomplished using heat treatment.

Aspect 58. The method of aspect 57, wherein the heat treatment is carried out using an initial ramp to a final temperature of from about 80° C. to about 200° C. followed by holding at the final temperature for a first period of time.

Aspect 59. The method of aspect 58, wherein the first period of time is from about 1 to about 2 hours.

Aspect 60. The method of any one of aspects 57-59, wherein the heat treatment produces a higher oxidation state of a metal.

Aspect 61. The method of aspect 60, wherein the higher oxidation state of the metal comprises CuO.

Aspect 62. The method of any one of aspects 57-61, wherein the heat treatment causes the particles to sinter.

Aspect 63. The method of any one of aspects 51-62, wherein contacting the substrate with particles comprises applying a suspension of a metal oxide in a solvent to the substrate and allowing the solvent to dry.

Aspect 64. The method of aspect 63, wherein the metal oxide is Cu₂O.

Aspect 65. The method of any one of aspects 51-64, wherein the solvent is ethanol.

Aspect 66. The method of any one of aspects 51-65, further comprising coating the substrate with a solution of a polymer and drying the substrate prior to step (a).

Aspect 67. The method of any one of aspects 51-66, further comprising:
(c) optionally heating the substrate; and
(d) treating the substrate with argon plasma.

Aspect 68. The method of any one of aspects 51-52 or 63-67, wherein the polymer comprises polyurethane and the metal oxide comprises Cu₂O.

Aspect 69. The method of any one of aspects 51-52 or 63-67, wherein the particles comprise silica, silicate, glass, or any combination thereof.

Aspect 70. The method of aspect 69, wherein step (b) is accomplished using sol-gel treatment or heat treatment.

Aspect 71. The method of aspect 69 or 70, wherein the silica, silicate, or glass particles comprise amine groups, ammonium groups, or any combination thereof.

Aspect 72. The method of any one of aspects 51-71, further comprising:
(e) blowing a stream of a gas over the antimicrobial film to remove unbound materials.

Aspect 73. The method of aspect 72, wherein the gas comprises argon, nitrogen, air, or any combination thereof.

Aspect 74. A method for making an antimicrobial film, the method comprising:
(a) admixing a film precursor and a metal or metal oxide in a solvent to form a first mixture;
(b) depositing the first mixture on a substrate; and
(c) evaporating the solvent from the first mixture on the substrate to form the antimicrobial film.

Aspect 75. The method of aspect 74, wherein initiation of polymerization occurs upon admixture formation in step (a), over time, at elevated temperature, due to evaporation of a solvent, upon exposure to light, or any combination thereof.

Aspect 76. The method of aspect 74, wherein the film precursor comprises one or more polymers.

Aspect 77. The method of aspect 76, wherein the one or more polymers are in the form of particles, and wherein the method further comprises heating the particles above a glass transition temperature of the particles prior to or during step (c) to facilitate curing of the particles to form the antimicrobial film.

Aspect 78. The method of aspect 74 or 75, wherein the film precursor comprises one or more polymerizable monomers and wherein drying the first mixture on the substrate further comprises polymerizing the monomers.

Aspect 79. The method of aspect 74, wherein the film precursor comprises dopamine hydrochloride.

Aspect 80. The method of aspect 79, wherein the antimicrobial film comprises a polydopamine film.

Aspect 81. The method of any one of aspects 74-80, wherein the metal or metal oxide comprises Ag, Cu, Zn, CuO, Cu₂O, ZnO, MgO, TiO₂, Ag₂O, Fe₂O₃, Sb₂O₃, Al₂O₃, or any combination thereof.

Aspect 82. The method of any one of aspects 74-80, wherein depositing the first mixture on the substrate comprises spraying the first mixture on the substrate, drop casting the first mixture on the substrate, immersing the substrate in the first mixture, or any combination thereof.

Aspect 83. The method of any one of aspects 74-80, wherein drying the first mixture on the substrate comprises drying in an oven, blowing a gas over the first mixture on the substrate, or a combination thereof.

Aspect 84. The method of any one of aspects 74-84, wherein the substrate comprises glass, a fiber, a textile, wood, tile, acrylic, metal, concrete, veneer, or any combination thereof.

Aspect 85. The method of aspect 84, wherein the substrate comprises a fiber, further comprising forming a textile from the fiber.

Aspect 86. The method of aspect 84 or 85, wherein the textile comprises a knitted textile, a woven textile, a nonwoven textile, or any combination thereof.

Aspect 87. The method of aspect 86, wherein the nonwoven textile comprises a meltblown textile.

Aspect 88. A method for making an antimicrobial film, the method comprising:
(a) coating a substrate with a film precursor;
(b) drying the film precursor on the substrate to form a coated substrate; and
(c) contacting the coated substrate with a solution comprising metal ions.

Aspect 89. The method of aspect 88, wherein the film precursor comprises one or more polymerizable monomers and wherein drying the first mixture on the substrate further comprises polymerizing the monomers.

Aspect 90. The method of aspect 88, wherein the film precursor comprises dopamine hydrochloride.

Aspect 91. The method of aspect 89, wherein the antimicrobial film comprises a polydopamine film.

Aspect 92. The method of any one of aspects 88-91, further comprising softening the film precursor on the coated substrate following step (b) to enhance adhesion of metal ions to the substrate.

Aspect 93. The method of aspect 92, wherein softening the film precursor is accomplished by heating above a glass transition temperature of the film precursor, contacting the film precursor with a solvent, or any combination thereof.

Aspect 94. The method of any one of aspects 88-93, wherein the metal ions comprise Ag ions, Cu ions, Zn ions, Mg ions, Ti ions, Fe ions, Sb ions, Al ions, or any combination thereof.

Aspect 95. The method of any one of aspects 88-94, further comprising, following step (c), rinsing the coated substrate, drying the coated substrate, or both.

Aspect 96. The method of any one of aspects 88-95, wherein the substrate comprises glass, a fiber, a textile, wood, tile, acrylic, metal, concrete, veneer, or any combination thereof.

Aspect 97. The method of aspect 96, wherein the substrate comprises a fiber, further comprising forming a textile from the fiber.

Aspect 98. The method of aspect 96 or 97, wherein the textile comprises a knitted textile, a woven textile, a nonwoven textile, or any combination thereof.

Aspect 99. The method of aspect 98, wherein the nonwoven textile comprises a meltblown textile.

Aspect 100. A method for making an antimicrobial film, the method comprising:
(a) contacting a substrate with a solution or suspension comprising metal particles or metal oxide particles; and
(b) softening the substrate to enhance adhesion of the metal particles or metal oxide particles.

Aspect 101. The method of aspect 100, wherein the substrate comprises a fibrous mat or textile.

Aspect 102. The method of aspect 100 or 101, wherein the solution or suspension comprises a solvent, and wherein the method further comprises evaporating the solvent following step (a).

Aspect 103. The method of any one of aspects 100-102, wherein contacting the substrate comprises dip coating the substrate into the solution or suspension, drop casting the solution or suspension onto the substrate, or any combination thereof.

Aspect 104. The method of any one of aspects 100-103, wherein softening the substrate comprises heating above a glass transition temperature of the substrate, contacting the substrate with a solvent, or any combination thereof.

Aspect 105. The method of any one of aspects 100-104, wherein the metal or metal particles comprise Ag, Cu, Zn, mg, Ti, Fe, Sb, Al, or any combination thereof.

Aspect 106. A method for making an antimicrobial film, the method comprising:
(a) depositing a surface layer of a metal or metal particles on a substrate; and
(b) oxidizing or reducing the metal or metal particles.

Aspect 107. The method of aspect 106, wherein reducing the metal or metal particles comprises contacting the metal or metal particles with a reducing agent.

Aspect 108. The method of aspect 107, wherein the reducing agent comprises dimethylamine borane.

Aspect 109. The method of aspect 108, wherein depositing the surface layer of the metal comprises physical vapor deposition, chemical vapor deposition, electroless deposition, or any combination thereof.

Aspect 110. The method of any one of aspects 106-109, wherein the metal or metal particles comprise Ag, Cu, Zn, Mg, Ti, Fe, Sb, Al, or any combination thereof.

Aspect 111. The method of any one of aspects 106-110, wherein the substrate comprises glass, a natural or synthetic fiber, a textile, wood, tile, acrylic, metal, concrete, veneer, a polymer film, or any combination thereof.

Aspect 112. The method of aspect 111, wherein the substrate comprises a synthetic fiber or a polymer film, further comprising softening the synthetic fiber or the polymer film following step (a) to enhance adhesion of the metal or metal particles to the substrate.

Aspect 113. The method of aspect 112, wherein softening the synthetic fiber or the polymer film is accomplished by heating above a glass transition temperature of the synthetic fiber or the polymer film, contacting the synthetic fiber or the polymer film with a solvent, or any combination thereof.

Aspect 114. The method of any one of aspects 106-113, further comprising applying a coupling agent to the metal, metal particles, or the substrate prior to step (a) to enhance adhesion of the metal or metal particles to the substrate.

Aspect 115. The method of aspect 114, wherein the coupling agent comprises a silane, a trimethylolpropane derivative, an epoxide, or any combination thereof.

Aspect 116. The method of aspect 111, wherein the substrate comprises a fiber, further comprising forming a textile from the fiber.

Aspect 117. The method of aspect 111 or 116, wherein the textile comprises a knitted textile, a woven textile, a nonwoven textile, or any combination thereof.

Aspect 118. The method of aspect 117, wherein the nonwoven textile comprises a meltblown textile.

Aspect 119. The method of any one of aspects 51-118, wherein the substrate comprises a backing material, and wherein removing the backing material enables application of the antimicrobial film to an existing article comprising an original surface.

Aspect 120. The method of aspect 119, wherein the substrate further comprises an adhesive in contact with the backing material.

Aspect 121. The method of aspect 119, further comprising removing the antimicrobial film from the existing article after a period of use.

Aspect 122. The method of aspect 121, wherein removing the antimicrobial film restores the original surface.

Aspect 123. The method of any one of aspects 51-122, wherein the substrate comprises an article to be coated directly with the antimicrobial film.

Aspect 124. A method for making an antimicrobial film, the method comprising:
(a) contacting a substrate comprising a plurality of pores with a polymer, wherein the polymer enters at least a portion of the plurality of pores, forming a porous polymer coating; and
(b) depositing a metal or metal oxide on the porous polymer coating.

Aspect 125. The method of aspect 124, wherein the polymer is dissolved in a solvent.

Aspect 126. The method of aspect 124, wherein the solvent comprises acetone, water, or any combination thereof.

Aspect 127. The method of aspect 124-126, wherein the polymer comprises polydopamine, polymethylmethacrylate (PMMA), or any combination thereof.

Aspect 128. The method of aspect 124-127, wherein the metal or metal oxide is deposited using electroless deposition.

Aspect 129. The method of any one of aspects 51-128, wherein the antimicrobial film is resistant to debonding from the substrate when treated with a surface disinfectant.

Aspect 130. The method of aspect 129, wherein the surface disinfectant comprises ethanol, a bleach solution, or any combination thereof.

Aspect 131. The method of aspect 130, wherein the surface disinfectant is a solution comprising about 70% ethanol.

Aspect 132. The method of aspect 130, wherein the surface disinfectant is a solution comprising about 3% bleach.

Aspect 133. An antimicrobial film produced by the method in any one of aspects 51-132.

Aspect 134. The antimicrobial film of any one of aspects 1-47 or 133, wherein the antimicrobial film is gray or white.

Aspect 135. The antimicrobial film of any one of aspects 1-47 or 133, wherein the antimicrobial film is transparent.

Aspect 136. The antimicrobial film of any one of aspects 1-47 or 133-135, wherein the antimicrobial film is flexible.

Aspect 137. An article comprising the antimicrobial film of any one of aspects 1-47 or comprising an antimicrobial film made by the method of any one of aspects 51-136.

Aspect 138. The article of aspect 137, wherein the article comprises a light switch, a door handle, a faucet handle, a railing, a piece of medical equipment, a bed rail, a cooking or food preparation surface, a surface in a retail store, a mass transit vehicle surface, an automobile surface, a hospital surface, a smartphone, a tablet computer, a cover for a personal electronic device, a computer mouse, a keyboard, a touch-screen, a screen protector for a touch-screen, a retail check-out facility or device, furniture, carpet, upholstery, equipment or machinery control surfaces, food packaging, athletic equipment, toilet seats, toilet flushing handles, communal religious articles, a packaging material, personal protective equipment, a filter, an article of apparel, an elevator button, a mirror, an acrylic divider, a polycarbonate surface, a sapphire surface, or any combination thereof.

Aspect 139. The article of aspect 138, wherein the personal protective equipment comprises a lab coat or a face mask.

Aspect 140. The article of aspect 138, wherein the filter comprises an air purification filter.

Aspect 141. The article of aspect 140, wherein the air purification filter is used in a heating and air-conditioning system in a building.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Cu₂O Deposition on Glass

Cu₂O loaded glass has previously been demonstrated to have antiviral and antibacterial activity. However, loosely-bound layers on glass surfaces can be immediately damaged by touching, scratching, or even placement of a water droplet onto the surfaces. Thus, simple Cu₂O loading is not practical for daily use. Further, it is possible that some antimicrobial activity may result from particles having dislodged from the surface and maintaining activity in suspension, which may not be useful in coating applications because of cytotoxicity or the loss of antimicrobial activity of the film when the active particles are removed from the film.

### Construction of Robust Thin Coatings of Cu₂O on Glass

A commercial polyurethane was applied to a glass slide using a sponge or paintbrush. Drying times from 2-8 minutes were evaluated; it was found that after about 6-8 minutes, the polyurethane was touch dry. Few to no visible blemishes were created when the dried polyurethane was touched with a gloved hand. In some aspects, the polyurethane was applied to the glass slide using a sponge; this enabled the creation of a thinner, uniform film.

Approximately 6-10 minutes after polyurethane application, a Cu₂O suspension was applied to the film. Various concentrations of Cu₂O in solvent were investigated. A water suspension was intended to reduce the solubilization of polyurethane in the Cu₂O delivery solvent; however, the water did not wet the polyurethane and spreading was difficult.

Both 10% w/w Cu₂O in ethanol and 25% w/w Cu₂O provided good results, i.e., a continuous layer of particles, often many particles thick, with few holes in the films, and was used in further experiments. Prior to further testing, the ethanol was allowed to dry for 5-10 min. Following Cu₂O application and drying, the coated slides were placed in a 120° C. oven for about 2 hours. Variations in w/w Cu₂O in the range 10-25% w/w Cu₂O produced good films but in some cases, 25% w/w Cu₂O was easier to spray coat.

### Film Properties

The films created by the above method were stable to light scratching with metallic tweezers as well as to water droplets.

The films were next examined using stereoscopic light microscopy. Advancing water contact angle was high at much greater than 90°, but the receding angle was low. The high advancing angle meant there was poor contact between the droplet and the solid, which in turn would lead to poor kinetics of antimicrobial activation. It is believed that the Cu₂O particles had been coated by the polyurethane, since the original Cu₂O suspension had been hydrophilic. Thus, it was decided to remove some polyurethane.

X-ray photoelectron spectroscopy (XPS) showed that the outer layer of the Cu₂O+polyurethane film had only about 10% of the expected level of copper, again suggesting the Cu₂O particles were coated in polyurethane. However, since the escape depth of the electrons is only about 1 nm, it was believed that the polyurethane coating was thin.

No change was visible after exposing the Cu₂O+polyurethane films to soap and water, 70% ethanol, or Lysol® disinfectant.

Additionally, the Cu₂O+polyurethane films were subjected to the ASTM D3359 adhesion test described herein. Three independent samples were tested using this method, with the average number of affected squares being 2.4±0.8.

### Example 2: Argon Plasma Treatment

Argon plasma was selected to sputter the treated surfaces in order to remove a thin layer of polyurethane and render the surface hydrophilic. Cu₂O+polyurethane films were prepared as described above and treated with argon plasma as follows:

25×75 mm coated slides were soaked in water for about 5 min to remove free Cu₂O particles, if any, from the surfaces. Samples were subsequently cut into 12×15 mm sizes and blown with nitrogen gas to remove glass particles. Samples were placed in a vacuum chamber (<200 mTorr) and flushed with argon for 10 minutes under dynamic vacuum. Samples were then plasma treated for 3 min at 100 W.

Following plasma treatment, the films were hydrophilic. Water entered the film and is believed to have made good contact with the film interior. It is believed the interior surface of the film consisted of exposed Cu₂O with polyurethane forming menisci between the particles to hold the film together.

After a period of more than one day, the film became hydrophobic, and water did not penetrate into the film. This film was tested for the ability to inactivate SARS-CoV-2 in millimeter-sized droplets. The results showed a 39× reduction (1.6 log) of virus after 1 hour, a 230× reduction (2.4 log) of virus after 3 h and no detectable virus after 1 day, where the detection limit was at TCID50/mL, which was a 6000× reduction (3.8 log). These results showed the ability of the inactivation layer to inactivate the virus. By increasing the wettability of the pores, suspensions of virus will be able to infiltrate into the pore structure that also contains the inactivation layer. Once inside the pores, the virus needs to diffuse only over the approximate dimension of the pore to reach the inactivation layer. This contrasts with the need for diffusion of the dimension of the droplet to reach the inactivation layer. Diffusion time increases with distance, sometimes scaling with the square of distance. Diffusion to the inactivation layer takes substantially less time inside the pore structure, so creating wettability of the pores is expected to cause much faster inactivation of SARS-CoV-2 that shown in the results above.

### Example 3: Fabrication and Characterization of Cupric Oxide Films

### Materials

Cuprous oxide micro particles type HP III Type UltraFine-5 (95.6% Cu₂O, 3.2% CuO and 0.1% Cu with trace lead, cadmium and arsenic, mean particle size 5.1 μm and mode 5.5 μm) were purchased from American Chemet Corporation. 100% Ethanol (ACS grade), 70% ethanol (Reagent Grade) and glass slides (25×75×1 mm) were obtained from VWR. Stainless steel 302 shim Precision Brand (unpolished ASTM A666, thickness 0.3 mm) was purchased from Amazon. The steel was cleaned with acetone and ethanol, and subsequently washed with soap and water for one hour. Concentrated bleach (7.5% sodium hypochlorite) was purchased from Kroger and water was from a Milli-Q Reference water purification system.

### Fabrication of CuO Coating

CuO thin films were prepared by thermal oxidation of Cu₂O followed by sintering. A 10% Cu₂O in ethanol suspension was sonicated for 6 minutes to yield a uniform dispersion. Glass slides were cut into 11×11 mm pieces, rinsed with 100% ethanol and then 0.1 mL of the Cu₂O suspension was applied on the surface. At this point, samples were left to dry at room temperature for approximately 20 minutes and then heat treated in a furnace at 120° C. for 10 minutes 350° C. for 10 additional minutes and 700° C. and for two hours to oxidize and undergo early-stage sintering to create necks between the particles. Successful experiments were also conducted with final temperatures below 700° C. (e.g., in the range of 400° C. to 700° C.). The furnace thermostat was returned to room temperature and the coated samples were cooled slowly overnight. The conversion from cuprous to cupric oxide was obvious from the change in color of the coating from red-brown to graphite-colored.

### XRD, XPS, and SEM

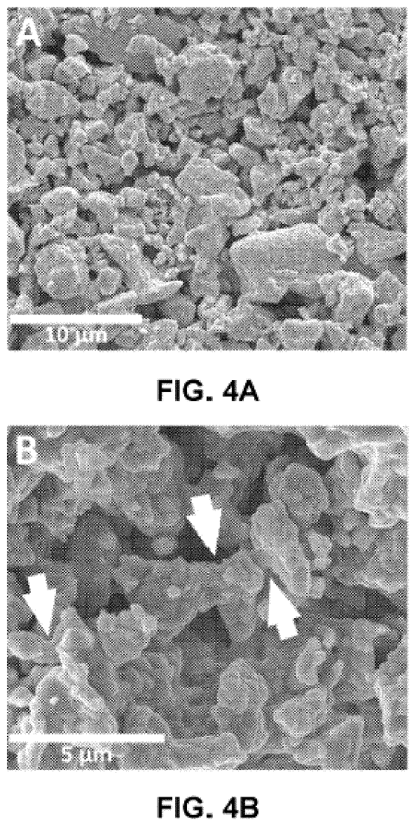

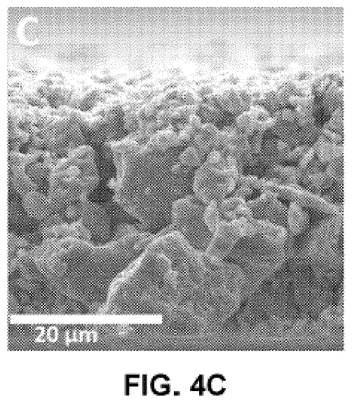

The X-ray diffraction (XRD) pattern obtained from a Bruker D8 Advance diffractometer (monochromatic Cu Kα x ray, wavelength=1.5418 Å) was used to identify structure of the oxidation product. X-ray photoelectron spectroscopy (XPS; PHI VersaProbe III with a monochromatic Al Kα source of 1486.6 eV) and electron-dispersive X-ray spectroscopy (EDX; BrukerQuantax) were used to study the chemical composition of the surface of the film. Scanning electron microscopy (SEM; FEI Quanta 600FE-ESEM) was utilized to examine the coating morphology and film thickness. SEM images of the films are shown in FIGS. 4A-4C.

### Contact Angle

The coating was designed to be hydrophilic to enhance the contact area between the droplet and the surface of CuO. The contact angle of 5 μL of water was measured using a First Ten Angstroms FTA125 to evaluate the hydrophilicity of the film. The FTA instrument was also used to generate the images of imbibition.

### ASTM D3359 Adhesion Test

The Adhesion performance of coated CuO films on substrates was assessed according to section 13 of ASTM D3359 standard code using a cross-hatch grid. An 11×11 grid of cuts spaced 1 mm apart was cut on samples. The surface was cleaned with an ultra-soft brush, and then a piece of tape was applied on the grid and rubbed with a rubber eraser to ensure a uniform contact. After 90 seconds of application, the tape was removed rapidly while bent through about 180 degrees. Subsequently, the area was inspected using an illuminated magnifier and rated on a scale of 0B to 5B, with 5B assigned for perfect adhesion, to evaluate the adhesion performance according to standard ASTM D3359 classification of adhesion chart.

### Disinfection/Adhesion Test

A variant of ASTM D3359 method B was used to evaluate the robustness performance of CuO coating against disinfection methods. After inscribing the cross-cut pattern, the coating was soaked in 70% ethanol or 3% bleach for 20 minutes, then dried before applying the tape.

### Drying Times

The test solid was placed on an A&D Company balance with 0.1 mg resolution. A 5 μL drop was placed on the solid at 22° C. and 35% relative humidity and the mass was measured at 1 minute intervals until the mass dropped below the resolution of the balance. Results are average of three tests, and saliva was from three different individuals.

### Example 4: SARS-CoV-2 Inactivation Test

Vero E6 cells were used to prepare virus stock and for to test the viability of the virus by microscopic observation of the cytopathic effect caused by the virus. The cells were cultured at 37° C. and 5% CO₂ in 2% fetal bovine serum and 1% v/v penicillin-streptomycin in Dulbecco's modified Eagle medium. The Hong Kong index SARS-CoV-2 virus was used in the tests and 0.5% (w/v) bovine serum albumin and 0.1% (w/v) glucose in Earle's balanced salt solution with a pH of 7.4 was used a viral transport medium.

Inactivation of the virus by the CuO film was examined as follows. The CuO or control film was initially disinfected with 70% ethanol in water followed by drying in air atmosphere at 37° C. overnight. A 5 μL droplet containing 6.2×10⁷ (7.8 log unit) TCID₅₀/mL of the virus was spotted on the test solid at 22-23° C. and 60-70% humidity, and after a predefined time, the coating was immersed in 300 μL of viral transport medium to elute the virus. The active virus within the eluted droplet was assessed using a 50% tissue culture infective dose (TCID₅₀) assay using Vero E6 cells. The TCID₅₀ assay consists of making a series of 3.16× (i.e. half log) dilutions of the eluted virus. Cells on 96-well plates were exposed to one of the dilutions, with quadruplicates of each dilution. The cells were then incubated at 37° C. and 5% CO₂. After five days, the cells were assessed for any cytopathic effect. The dilution at which 50% (2 of 4) of the Vero E6 cell cultures showed a cytopathic sign is called TCID₅₀/mL. Three independent samples (i.e. a new solid sample and a new inoculation of virus) were tested for each time point and the virus inactivation at each time point was calculated based on the reduction of log(TCID₅₀/mL) as follows:

$$log reduction = mean [ {log}_{10} ( \frac{control titer}{sample titer} ) ] \qquad ( 1 )$$

$$\% reduction = ( 1 - 1 {0}^{- log reduction} ) \times 100 \qquad ( 2 )$$

### Statistical Analysis

Results are listed as mean±standard deviation or 95% confidence interval, as applicable. TCID₅₀/mL data has been transformed to log (TCID₅₀/mL) before statistical analysis because deviations of log (TCID₅₀/mL) from the mean log (TCID₅₀/mL) were distributed normally in this work. The statistical package R was used as indicated, and otherwise Excel was used for analysis. p-values less than 0.05 were considered significant.

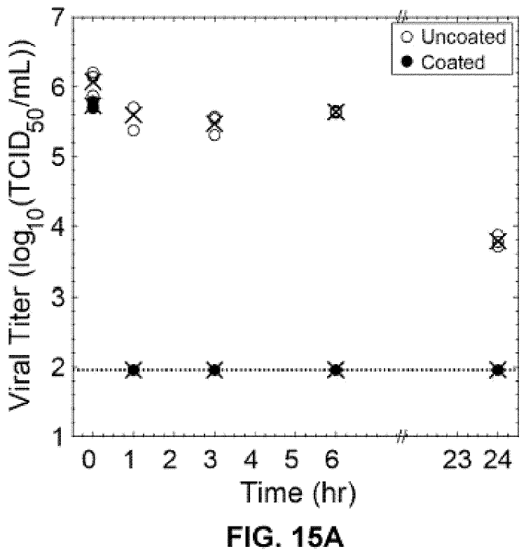

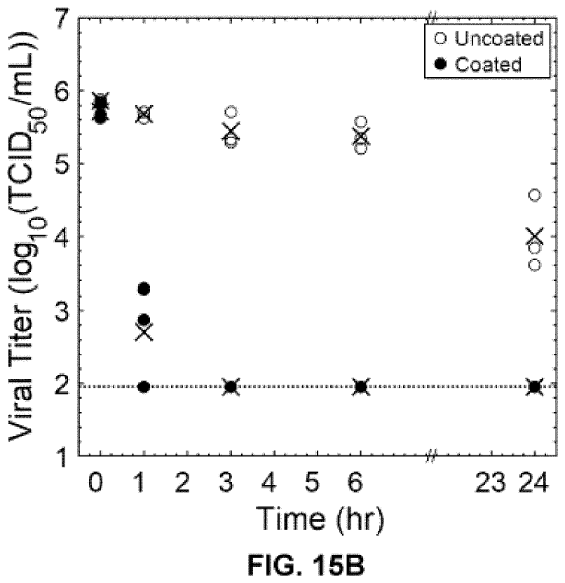

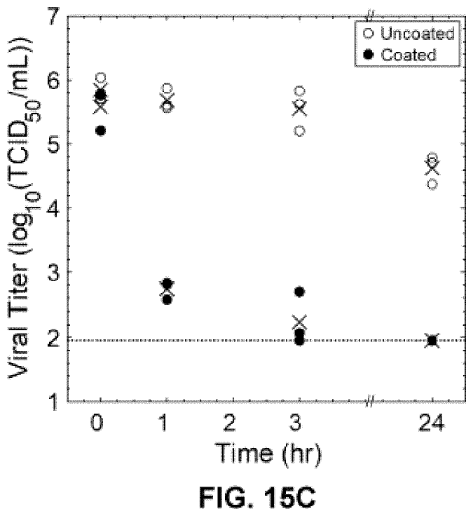

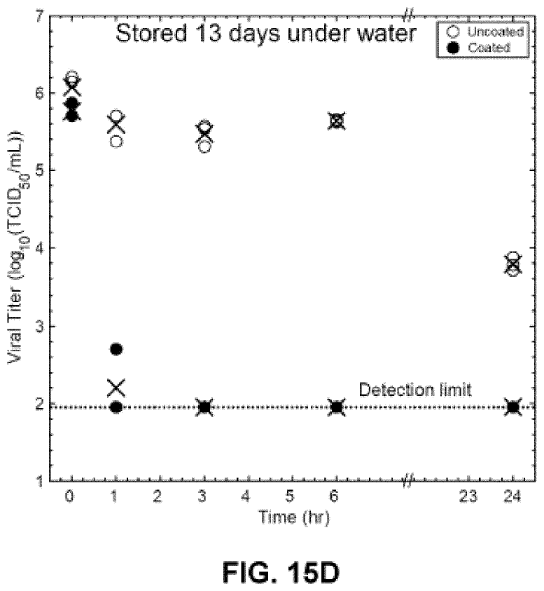

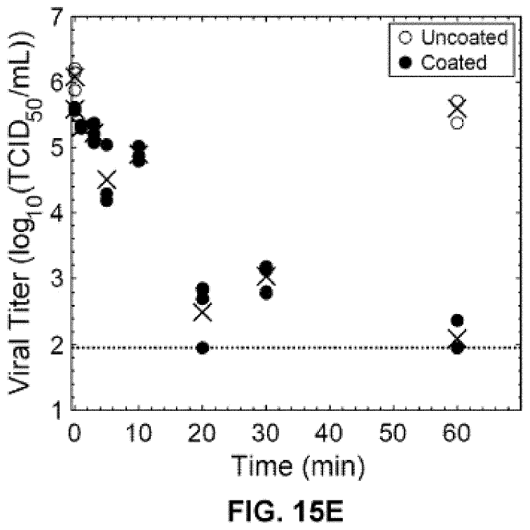

Results of selected microbial and viral inactivation experiments can be seen in FIGS. 15A-15E, 16A-16B, and 17A-17D.

### Example 5: Analysis of Film Composition

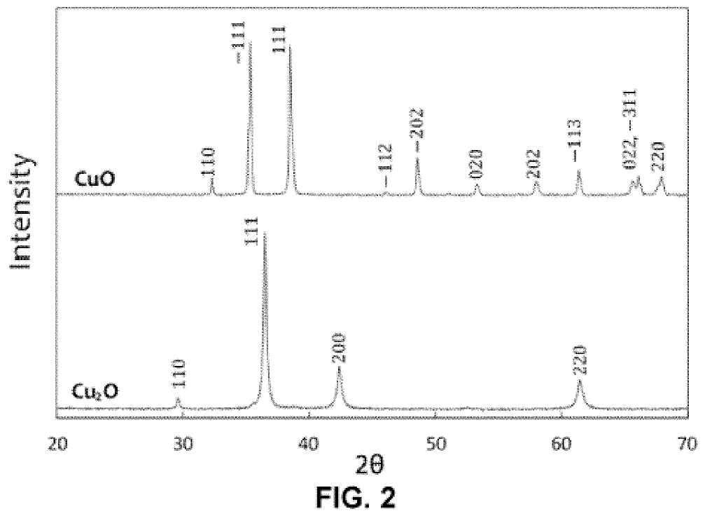

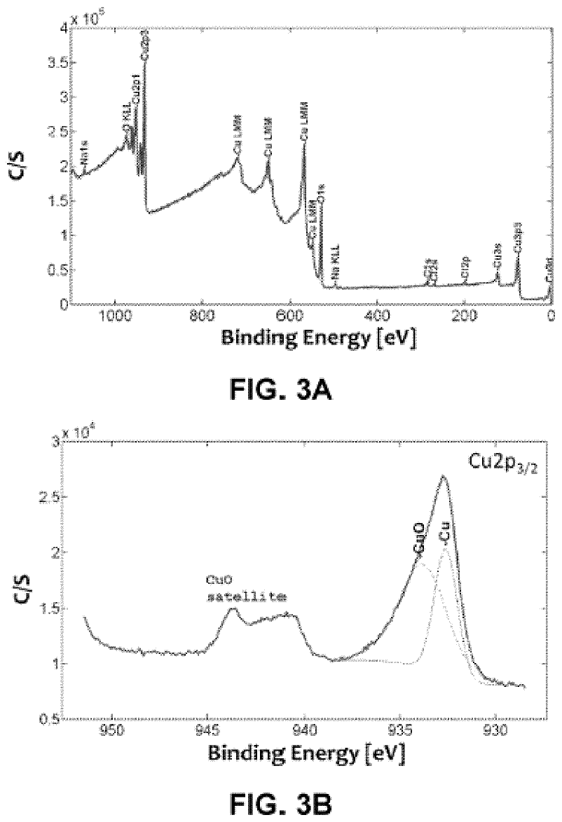

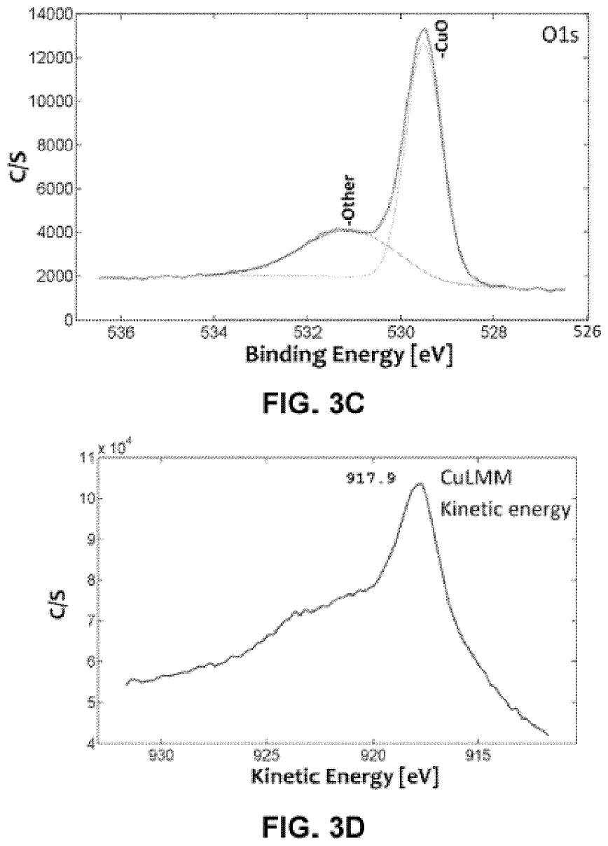

Cu₂O has a red-brown color, whereas CuO had a graphite color, so the conversion was visually obvious. The chemical identity of the coating was confirmed by XRD of the oxidized sample (FIG. 2), which was consistent with diffraction patterns of CuO in the literature, and demonstrated that the coating was composed of monoclinic CuO. The absence of peaks from the starting material (Cu₂O) showed that oxidation was complete, and the absence of other peaks demonstrated a low proportion of impurities. The outer nanometer or so of the surface of the coating was examined by XPS. FIG. 3A shows that Cu and O are the primary elements, with the elemental composition of the surface being: 47.5% O, 40% Cu, 9.2% C, 1.7% Cl, and 1.6% Na. Carbon is a common contaminant in XPS. The oxidation state of the Cu was identified from the Cu₂p_{3/2} spectrum (FIG. 3B), which contained a broad peak at 932-934 eV and a characteristic satellite feature of CuO at 940-945 eV. The O1s spectrum is presented in FIG. 3C. The peak at 932-934 eV was deconvoluted into two peaks at 932.6 and 933.8 eV (E_{b}). The peak at 933.8 eV was assigned to CuO and the peak at 932.6 eV could be either Cu metal or Cu₂O. The Cu L₃M₄₅M₄₅ Auger spectrum (FIG. 3D) was used to distinguish between these two possibilities. The single peak with a kinetic energy of 917.9 eV (Eₖ) gave a Modified Auger Parameter of 1851.7 eV (E_{b}+Eₖ) was in excellent agreement with the known value of CuO (1851.7 eV), showing that CuO was the main species on the surface and not Cu₂O and therefore the 932.6 eV peak was elemental copper. The presence of elemental copper is consistent with prior work demonstrating reduction of CuO in XPS spectra. The calculation of the Cu:O elemental ratio on the surface was complicated by two factors: (1) adventitious oxygen on the surface, such that only 67% of the oxygen was in the form of copper oxides, and (2) elemental copper on the surface: only 65% of the copper was Cu²⁺. After correcting for these effects, the ratio of Cu as copper oxides to oxygen bonded to Cu was 0.99, consistent with CuO on the surface of the coating. The chemical composition of the coating was also measured by EDX from two different points on each of three independent samples. EDX samples a layer about 1 μm in thickness. The average Cu:O ratio was 1±0.3, consistent with the XPS and XRD results.

Our aim was to fabricate a macroporous coating to enhance liquid infiltration (imbibition) of infectious droplets. SEM images of the microstructure are shown in FIGS. 4A-4C and reveal that 1) the coating was porous and 2) necks have been generated between CuO particles due to early-stage sintering, which is necessary to create a robust coating. The cross-sectional image showed a uniform surface with average 32±1 μm thickness (95% confidence interval from two measurements), and confirmed the porous nature of the coating. The pore volume was estimated by measuring the volume of water that could be imbibed into a measured total volume of film (measured thickness from SEM and macroscopic 1.21 cm² area). The approximate pore volume was 59±6% (95% confidence interval from 3 measurements).

### Example 6: CuO Films Rapidly Reduce SARS-CoV-2 Activity

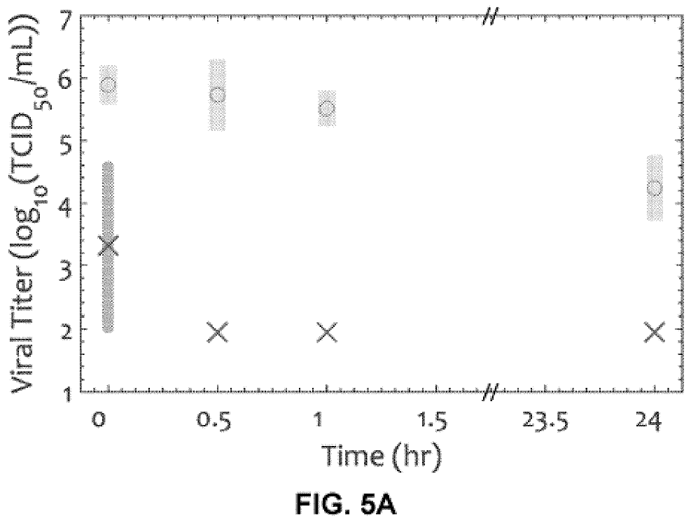

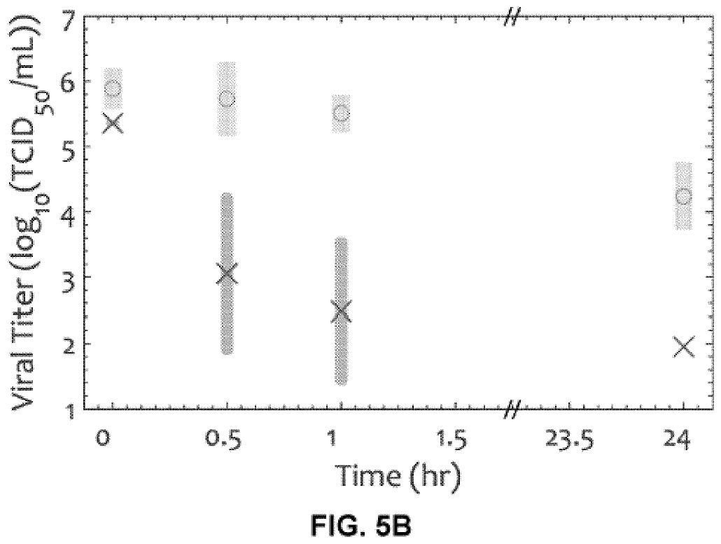

The ability of SARS-CoV-2 to infect Vero E6 cells after being deposited on surfaces is shown in (FIGS. 5A-5B). Whereas the ability to infect cells after deposition on glass was reduced by only 60% after one hour, the activity of the virus recovered from the CuO coating was reduced by more than 99.9% on average. When the activity of virus from the coating to the glass is compared at the same one-hour time period, the average log reduction (equation 1) was 3.11 and the % inactivation (equation 2) was 99.9%. The 95% confidence interval for the reduction is that the infectivity was reduced by more than 99.35% in one hour (one tailed, heteroscedastic, calculated using R software). This performance is similar to the results obtained for the disclosed Cu₂O coating, and distinctly superior to the published results for inactivation on copper surfaces, which was <90% reduction comparing the 0 h to the 1 h time point and 8 h to reach the detection limit, which was <99% reduction compared to the 0 h time point. After only 30 minutes there is already a large viable virus reduction on the CuO coating compared to the uncoated glass: on average 99.8%. The 95% confidence interval for the reduction at 30 minutes was that more than 96% of the virus was inactivated (one tailed, heteroscedastic, interpolation of glass results at 0 h and 1 h assuming constant half-life, calculated using R software).

The results demonstrate very rapid reduction of infection by SARS-CoV-2 from a coating that can be used on objects such as metal door handles that can be heat treated. Herein, it is also shown that the coating is robust, as expected for a sintered coating of mineral particles.

### Example 7: Material Leaching from the Coating does not Inactivate SARS-CoV-2

Study of the mechanism of inactivating of SARS-CoV-2 by cupric oxide is beneficial for the design of future antiviral coatings and surfaces. A number of reviews have summarized how copper may attack pathogens, and the mechanisms include the release of cupric ions, production of reactive oxygen species (ROS), surface catalysis, or contact killing with the solid. Herein, a test is described to evaluate the antiviral property of species that are leached from the disclosed coating or created by this coating. The hypothesis was that the virus was inactivated by species that are dissolved or suspended in the liquid after contact with the solid, and was tested by exposing the virus to the leachate from the film, without exposing the virus to the coating itself. The CuO coating was initially soaked in 300 μL of viral culture medium (without any virus) for 24 hours at room temperature. Next, 135 μL of the medium was mixed with 15 μL of the virus and the mixture was incubated at room temp for one hour (the time period of more than 99.9% inactivation by the film) or 24 hours (an exaggerated time scale to allow for more subtle effects) before assessing the viability of SARS-CoV-2 to infect Vero E6 cells via the standard TCID₅₀ measurement. Note that the virus was never in contact with the coating. This protocol was similar to that reported by Sunada et al.

Results shown in FIG. 6 demonstrate that the infectivity of the virus when exposed to the CuO leachate compared was similar to when exposed to the culture medium (p=0.73, ANOVA with two factors—time and solid). In contrast, when Cu₂O coating was tested instead of a CuO coating, the TCID₅₀/mL was reduced by over 10×, indicating that this experiment had the capability to resolve a reduction (positive control, p=0.01). The hypothesis that dissolved material was the cause of inactivation was rejected, and it was concluded that contact killing is a mechanism of SARS-CoV-2 inactivation. These findings are consistent with the previously reported results for antibacterial properties of CuO.

Contact inactivation of SARS-CoV-2 by CuO may be aided by an attractive charge-charge interaction. The culture medium has an ionic strength of about 0.15, which corresponds to a Debye-length of about 0.8 nm, which is still sufficiently long for electrostatic interactions to occur at short range. The spike proteins which protrude furthest from the envelope have 10 cationic amino acids, 7 anionic amino acids and one histidine, giving a net charge of about positive 3.5 at pH 7.4. The envelope (E) protein also has a net positive charge. Cupric oxide has a negative zeta potential (−17 mV) in culture medium. SARS-CoV-2 should therefore be attracted to cupric oxide via an electrostatic interaction. It is also possible that this charge-charge interaction may be part of the mechanism of inactivation.

### Example 8: Film Properties

### Contact Angle

The CuO coating has been designed and engineered to be hydrophilic to rapidly draw in the infected droplet and inactivate the virus. Some cuprous oxide-based anti-SARS-CoV-2 coating that lose hydrophilicity over time because of the presence of polyurethane. It is expected that the cuprous oxide coating would have improved performance if it were to remain hydrophilic and therefore allow imbibition into the coating. Herein is disclosed a coating without polyurethane that will not age or have polyurethane covering on part of the active surface. The hydrophilic nature of the coating was maintained over an eight-week period. A water droplet rapidly wets and imbibes at any time during the 8 weeks test period, and advancing, sessile, and receding contact angles were <10°.

### Adhesion Tests

Possible future applications where the CuO coating could be used on store door handles, public transportation railings and perhaps railings in medical environments that are sometimes made from steel are envisioned. Because such hand holds are commonly disinfected during the pandemic, it was tested whether the coating retained its physical integrity after exposure to common disinfectants using ASTM D3359 method B test where the adhesion was assessed in combination with disinfection by either 70% ethanol or 3% bleach in water. Approximately one-inch square pieces of stainless steel 302 were cross-hatched according to ASTM D3359-B, then exposed to the disinfectant, then the adhesion was tested. The test was conducted on three independent samples for each disinfection condition. The cross-hatching creates initiation sites for coating failure but damage at these sites was very low: the average number of affected cells was 0.67 (no disinfection), 1.3 (3% bleach) and 0.5 (70% ethanol). The coating was rated 4B according to standard ASTM D3350 classification of adhesion.

### Example 9: Factors Affecting Inactivation Time

In principle, the time to inactivate the virus depends on two rates: the rate of transport to the active surface and the rate inactivation by the active ingredient. If transport is the rate-limiting step, then there is little point in accelerating the inactivation on contact. In general, the transport time is complex to calculate for a drying droplet on a surface. First, the transport depends on the mechanism. If the virus is inactivated by contact with a fixed solid, transport of the virus is the relevant quantity, whereas if inactivation is caused by dissolved ions, then the transport of the dissolved ions should be considered, as well as the time taken for dissolution to occur. Here, it is assumed that the Stokes-Einstein equation applies:

$$D = \frac{k T}{6 π η r} \qquad ( 3 )$$

Where k is the Boltzmann constant, T is the temperature, q is the viscosity, and r is the radius. The diffusion constant is inversely proportional to the radius of the species being transported. Therefore, the diffusion of virus will be much slower than of ions because the virus has a much greater radius (˜50 nm, including spike proteins) than metal ions (˜0.5 nm). Thus, transport of the virus is more likely important for contact killing. Since this data is consistent with a mechanism of contact inactivation, the effect of drying on the transport of the virus to the solid will be examined.

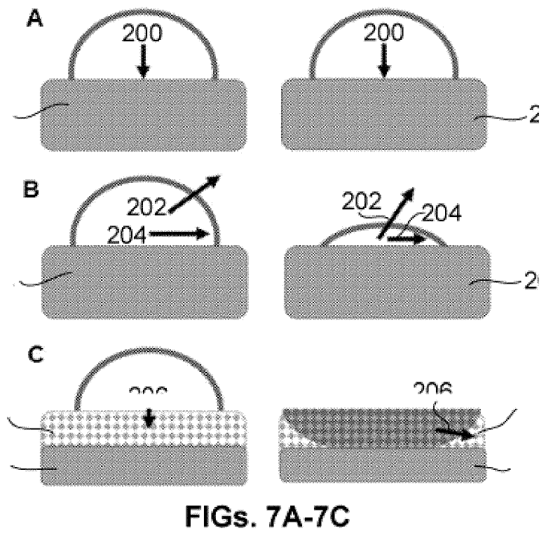

The diffusion distance in a droplet depends on the droplet size and contact angle of the droplet on the solid (FIGS. 7A-7C). Diffusion 200 of viral or microbial particles in a static droplet to a surface 208 can take up to several hours or more (FIG. 7A). In a drying droplet, evaporation 202 and advection 204 can decrease droplet size, speeding up contact of viral or microbial particles with the surface 208 (FIG. 7B). When a porous coating or film 210 is present on surface 208, imbibition 206 occurs. Imbibition draws the contaminated liquid into the pore space where diffusion distances are less than the pore size, which is controllable, and much less than the droplet size. Owing to smaller diffusion distances, the viral or microbial inactivation can occur in much less time on a porous film (minutes or less) (FIG. 7C) than on the non-porous film FIGS. 7A-7B). A large range of sizes is reported for respiratory droplets in air: <1 μm to 100 μm, for talking, and coughing, and much larger for sneezing, 300-900 μm, or even mm in size, which means that if spherical, the typical dimension is about 1 mm. The smaller droplets are more likely to evaporate quickly before settling, so the larger droplets which are deposited (>10 μm) are the most important here. So these 5 μL (r≈1 mm) test droplets are at the larger, but still relevant end of the spectrum. The initial contact angle on an impermeable surface also has an effect: the lower the angle, the smaller the average diffusion distance. Using a typical diffusion distance of 0.5 mm, the viscosity of saliva≈0.07 N s m⁻², and approximating to planar diffusion from the center of the droplet, the diffusion time will be on the order of many hours. For a non-evaporating sessile droplet on an impermeable solid diffusion alone cannot be relied upon to carry the virus to the surface of a film between two subsequent users of a communal object such as a door handle.

Drying of the droplet will clearly be a major factor in bringing the virus into contact with the solid. Deposition of particles onto impermeable solids from an evaporating droplet has been studied extensively, especially the phenomenon known as the “coffee ring effect.” The deposition depends on the presence of surface active agents and other species in the droplet. For respiratory droplets there will be biological polymers, salts and other ingredients. In brief, evaporation of the liquid leads to a diminishing droplet volume, but also sets up flows within the droplet, which together with surface tension gradients affect deposition. Particularly the diminishing size of the droplet, but also the convection will speed transport to the surface. In the final stages of dying, the concentration of any leachate may climb dramatically, if dissolution is out of equilibrium. The overall drying will depend strongly on the temperature and the humidity.

By creating a porous hydrophilic film that imbibes the droplet, as has been done here, the situation is changed considerably (FIGS. 7A-7C). The most important point is that, instead of diffusion over the millimeter scale of the droplet, once imbibition occurs, diffusion of virus need only occur over the designed size of the pore, which here is on the order of micrometers. This thousand-fold reduction in scale should make diffusion tenable for driving contact of the virus with the active surface. In addition, imbibing into a porous film removes the vicissitudes of the local temperature and humidity that are critical if drying is used to draw the virus into contact with the active solid. Clearly for hot, low humidity conditions, droplets will dry very quickly and draw the virus into contact with the solid but at high humidity drying will be slow.

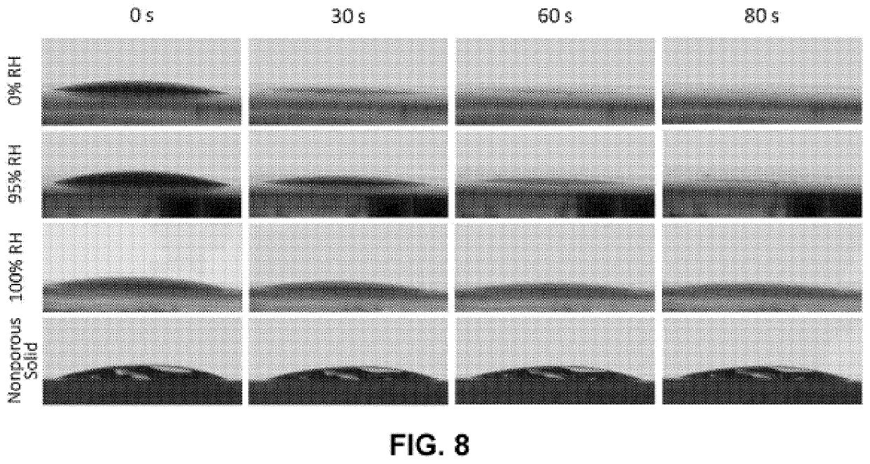

Imbibition into the disclosed coating would not be as effective if the pore space were already filled with water that condenses from the air. The Kelvin equation suggests that capillary condensation will only occur for large pores as the humidity approaches 100%. Calculation would require detailed knowledge of the pore geometry, which is in this case inhomogeneous; here imbibition of water into the CuO coating has simply been measured as a function of humidity. These results show that, in the range 0-95% humidity, a 5 μL droplet is imbibed into the film within 80 s (see FIG. 8), which is a suitable transport time for viral inactivation and suggests that the coating will be deployable over most of the normal range of humidity conditions. In fact, imbibition is not much slower at 95% humidity than at 0% humidity.

Although very small pores are advantageous for creating small diffusion distances, the viscous drag is important for imbibing the liquid into the solid. This should be considered for respiratory droplets. The Washburn equation approximates the distance travelled, L, into a pore of the coating for a given time:

$$L = \sqrt{\frac{γ {r}_{p} cos θ}{2 η} \cdot t} \qquad ( 4 )$$

where y is the solid-liquid interfacial tension, rₚ is the radius of the pore, θ is the contact angle and t is the time.

Our results showed that imbibition of 5 μL water into the disclosed coating was complete within about 80 s, which is a suitable time for inactivation of SARS-CoV-2. The rₚ/η scaling of L in Equation 4, suggests that imbibition of more viscous liquids such as saliva (≈0.07 N s m⁻²=70×water viscosity) that contain SARS-CoV-2, may require larger pore sizes to achieve similar imbibition times.

### Example 10: Additional Effects of Porous Film

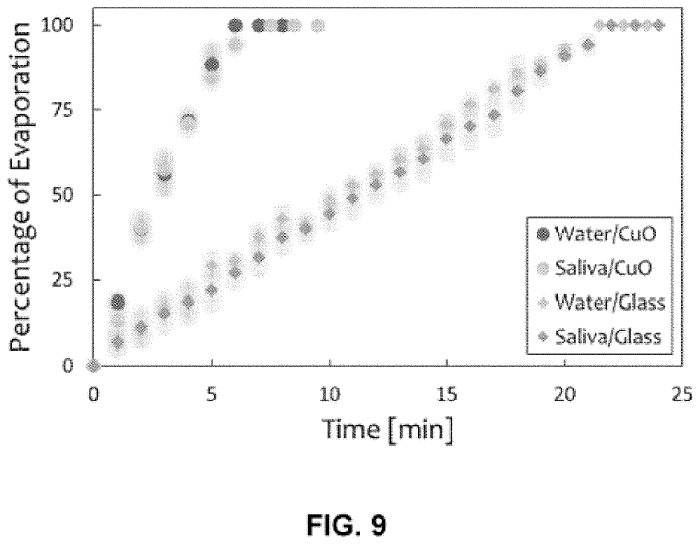

A porous film provides a much greater surface area than a smooth film. Whether the mechanism is contact inactivation or dissolution, the greater surface area is beneficial for inactivation via one of these surface process. In addition, the porous surface provides an opportunity for faster drying of a droplet. Faster drying reduces the time taken to pull the suspended virus into proximity with the active surface. In FIG. 9, the drying times on the porous CuO coating to the uncoated (no-porous) solid for both water and droplets of human saliva are compared. For both saliva and water, the drying rate was about three times as fast on the CuO film. On the CuO film, the droplet is effectively dry after about 10 minutes. Drying aids the process of pulling the virus into contact with the solid, and drying readies the surface for subsequent respiratory droplets. Improved drying time is therefore a significant advantage of a porous film for reducing transmission to subsequent users of communal objects.

An additional advantage of a porous film is that the active surface within the pore structure is provided with a degree of protection from abrasions and other insults that occur to the surface layers during normal usage. For comparison, molecular layers on an impermeable surface coating may be subject to rapid wear with associated loss of effectiveness.

### Example 11: Transparent Antimicrobial Coating of Cu₂O in PDA

### Fabrication

Glass slides were used as an example substrate since glass represents a primary surface where transparency is important. A 0.2% (w/w) suspension of Cu₂O microparticles (average diameter 5 μm) in 10 mM Tris buffer in water was prepared and sonicated for 1 h to disperse the particles. Dopamine hydrochloride was added to the suspension to make a final concentration of 0.05 g dopamine/L. The resulting suspension was deposited on a substrate (in this case, glass) and the substrate was placed in an oven at 80° C. for 30 min to dry. The deposition can be done by spray coating, dip casting or drop casting. Spraying is a very rapid method for applying the coating. The coating was blown with nitrogen gas before testing. In some biological testing experiments, the coating was also disinfected by immersion in 70% ethanol, but this step was not required for fabrication. In some examples, this procedure was repeated using Cu microparticles instead of Cu₂O microparticles. An additional transparent antimicrobial coating was prepared consisting of Ag₂O in a silica matrix.

### Results

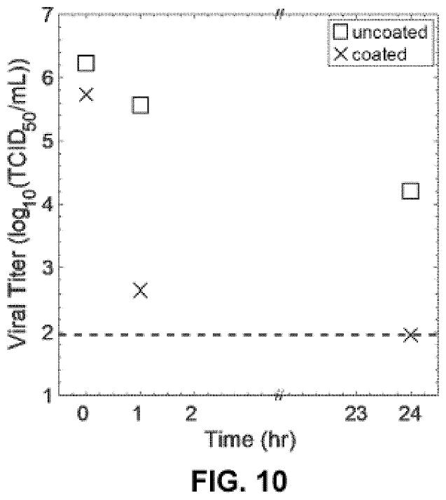

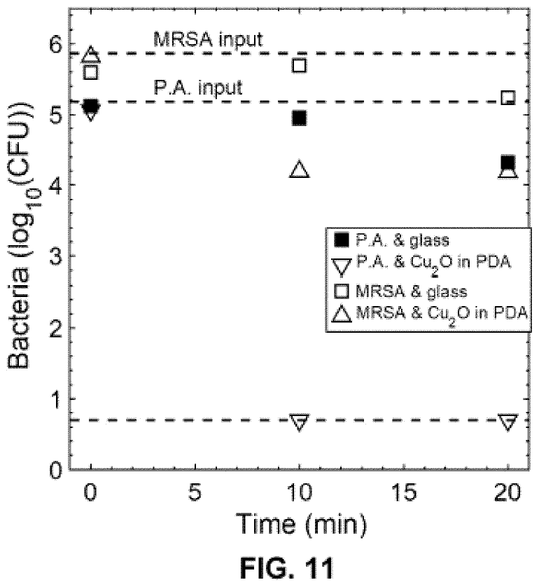

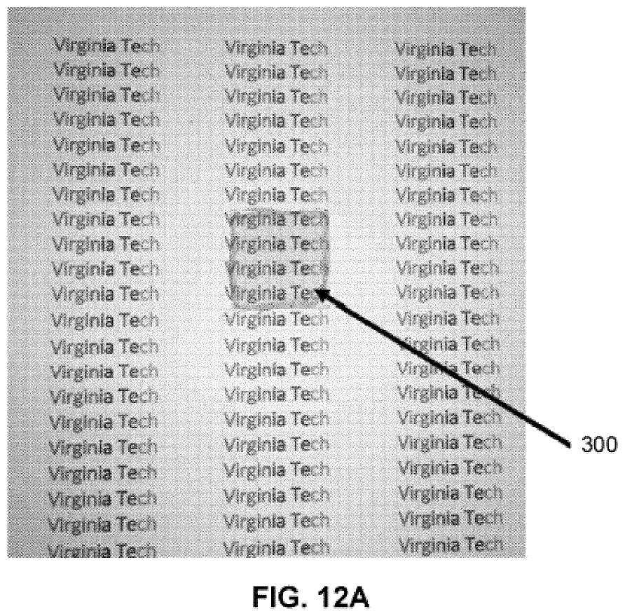

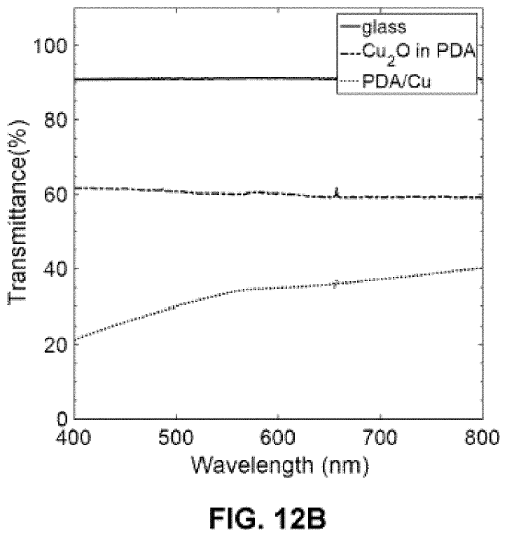

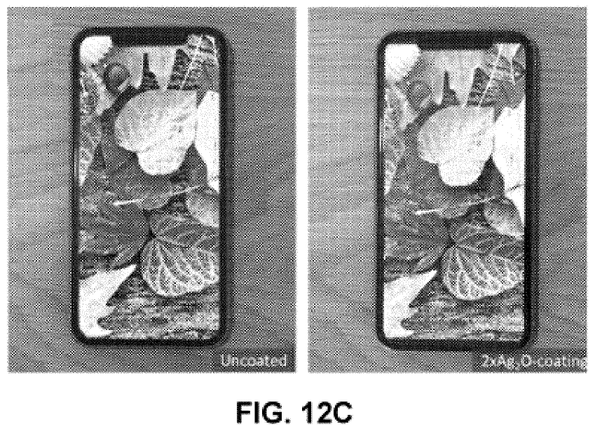

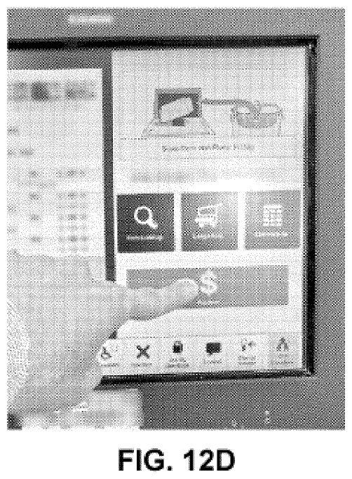

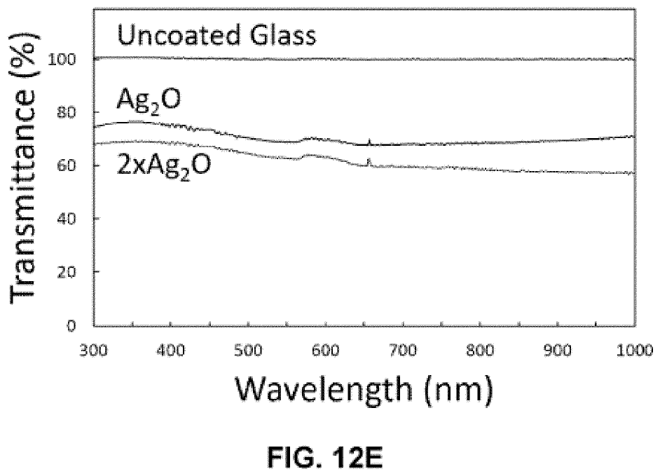

Inactivation of SARS-CoV-2 using a Cu₂O in polydopamine (PDA) film is shown in FIG. 10, while inactivation if Pseudomonas aeruginosa and methicillin-resistant Staphylococcus aureus by a Cu₂O in PDA film is shown in FIG. 11. Transparency of a film 300 over a computer screen is shown in FIG. 12A, while UV-Vis analysis of the film 300 is shown in FIG. 12B.

### Example 12: Transparent Antimicrobial Coating Made by Electroless Deposition of Cu on PDA-Coated Objects

### Fabrication

An object, such as a glass slide, is coated in a two-step procedure consisting of (1) coating in polydopamine and (2) growing Cu oxide particles. To coat in polydopamine, the object to be coated is immersed in 50 mL of 10 mM Tris buffer at 60° C. on a heated stirring plate. 0.25 g of dopamine hydrochloride was dissolved in this solution to make a concentration of 5 g/L (pH 8.5). The reaction was allowed to proceed for 4 h, then the solution was cooled to room temperature and the substrate was washed with DI water and dried under a nitrogen flow.

An aqueous solution containing 50 mM EDTA, 50 mM CuCl₂, and 0.1 M H₃BO₃ was prepared. This solution was blue in color and was stable when stored in the refrigerator. The solution was adjusted to pH 7.0 using NaOH.

50 mL of the solution was placed in a beaker on a heated stirring plate at 37° C. Immediately prior to use, 0.295 g of dimethylamine borane (DMAB) was added to the solution to make a total concentration of DMAB. A PDA film was immersed in the solution. When the electroless deposition reaction started, the solution color changed to dark green. The reaction was stopped after about 30 min and the PDA film was rinsed with DI water and dried with nitrogen gas.

### Results

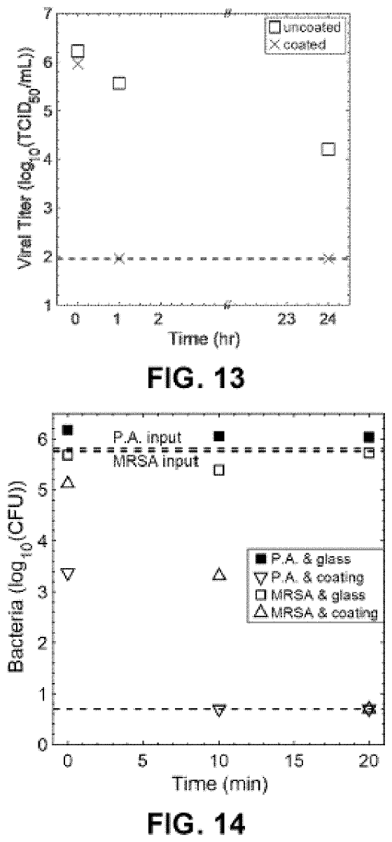

Inactivation of SARS-CoV-2 on a PDA film with copper nanoparticles deposited by electroless deposition is seen in FIG. 13, while inactivation of Pseudomonas aeruginosa and methicillin-resistant Staphylococcus aureus on a PDA film with copper nanoparticles deposited by electroless deposition is shown in FIG. 14. Transparency of a film 300 over a computer screen is shown in FIG. 12F, while UV-Vis analysis of the film 300 is shown in FIG. 12B.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### Example 13: Transparent Antimicrobial Coating Made by Incorporating Silver Oxide Particles into a Silica/Silicate Film Prepared by the Sol-Gel Process

### Fabrication

Silver oxide particles were synthesized by taking 600 mL of 0.01 M AgNO₃ in DI water and stirring while 1200 mL of 0.01 M NH₃ in DI water was added dropwise, and then the mixture was stirred for 10 minutes. Subsequently, 60 mL of 2 M NaOH was added dropwise. The addition of NaOH caused the solution to darken, demonstrating the synthesis of small Ag₂O particles. The suspension was left for 12 hours, during which time, the particles precipitated. After precipitation, the particles were washed three times with DI water and then three times with ethanol. Lastly, the supernatant liquid was decanted from the particles and particles were left to dry.

We describe here how glass was coated but other objects can be coated in a similar fashion. Glass slides where cut into 12×12 mm pieces and cleaned serially with DI water, 70% ethanol, 6M nitric acid and DI water respectively. Those glass pieces acted as the Ag₂O-free, control samples. To prepare the transparent silver oxide-coated surfaces, glass pieces were 02 plasma treated at a pressure of less than 200 Torr and 100 W for 5 minutes. Immediately after the plasma treatment, 34 μL of a suspension of Ag₂O in 2.8% (vol/vol) tetraethyl orthosilicate (TEOS) in ethanol solution was applied on the glass pieces. The volume of TEOS was a compromise between achieving good binding to the solid and not covering the Ag₂O particles. Substrates were then placed in partially sealed leveled containers to limit evaporation and the self-assembly of the particles accordingly.

Two different coatings that differed by the solids-loading of Ag₂O particles were prepared. The Ag₂O-coating had 5.0 mg/mL Ag₂O powder in suspension (1.2 mg of Ag₂O per mm2 of glass surface) whereas 2×Ag₂O-coating had 10 mg/mL Ag₂O powder in suspension (2.4 mg of Ag₂O per mm2). After two hours, the ethanol was evaporated and samples were transferred to a leveled sealed container in contact with vapors of 8 M DI water in ethanol and 7.62 M ammonia in DI Water for 20 hours. Next, the samples were heat-treated at 50° C. for one hr. Lastly, samples were blown with high pressure nitrogen, rinsed upside down in DI water for 10 minutes and dried with a nitrogen gas. We used cleaned glass and TEOS samples as controls in antimicrobial experiments.

### Results

The transparent nature of the coating is shown in FIGS. 12C-12E. FIG. 12C shows a smart phone with a screen cover. On the left the screen protector has no 2×Ag₂O film, and on the right, the screen protector is coated with the 2×Ag₂O film. After addition of the film, the image on the screen is clearly visible, with the colors and detail that was present before the coating was added. In addition, the function of the touch screen was maintained. Similarly, FIG. 12D shows a supermarket check-out screen. A glass piece with 2×Ag₂O film has been placed over the screen, and the check-out screen icon is still visible. FIG. 12E shows a UV-Vis spectrum of a glass slide, a glass slide with a Ag₂O film and a glass slide with 2×Ag₂O film. A high degree of transmittance is observed at all visible wavelengths, and the transmission is a weak function of wavelength so that the coating causes little change to the relative intensity of colors.

### Abrasion Resistance

The silver oxide coating (2×Ag₂O) was further tested for abrasion resistance using a modification of the United States Environmental Protection Agency Protocol “Interim Method for Evaluating the Efficacy of Antimicrobial Surface Coatings” published Oct. 2, 2020. The principal modification was to use 70% ethanol in water as the disinfectant because few individuals use bleach or hydrogen peroxide to disinfect phones or other electronic devices.

The substrate used for the testing was cleaned, degreased, and disinfected with 70% ethanol in water. A Gardco Abrasion tester D10V was used and was also disinfected with 70% ethanol solution in water. A tray and sponge holder (boat) were likewise disinfected. All items were allowed to dry completely.

The number of stroke cycles was set to 4 and the speed was set to 2.2 for the abrasion tester, where 1 stroke cycle is equal to 2 single passes. A sponge was autoclaved for 20 minutes and left in a laminar flow cabinet overnight to dry. 20 mL of 70% ethanol in water was poured into a small sterile container and the dried sponge was immersed in this for 10 minutes to wet. The wet sponge was used within 1 hour of application.

The sponge was placed into the boat and the weight o the boat was adjusted to 1 lb. The sponge extended a minimum of 5 mm beyond the rim of the sponge boat and the boat was assembled such that the whole force of the weight of the boat was exerted on the surface through the sponge.

Test samples were adhered side by side with double sided tape and face up. The abrasion tester was reset and one abrasion cycle (i.e. 8 single passes of the boat) on the test surfaces were conducted. Following one abrasion cycle, 70% ethanol in water was sprayed on the abrasion platform. The process was repeated until 10 abrasion cycles or 80 single passes were completed. The test samples were collected and blown with nitrogen to dry the samples. Test samples were stored in sterile petri dishes for antimicrobial efficacy testing.

Abraded silver oxide coatings (2×Ag₂O) on glass were tested for antimicrobial activity with Pseudomonas aeruginosa. No colonies survived on the silver oxide coating after one hour, and the reduction of colonies was greater than 99.9% compared to the uncoated solid.

The antimicrobial activity of the Ag₂O film and the 2×Ag₂O film when coated on glass is shown in FIG. 13. After one hour on the 2×Ag₂O film, the log reduction of P. aeruginosa is 3.44, the log reduction of S. aureus is 2.16, the log reduction of MRSA is 3.03 and the log reduction of SARS-CoV-2 is 2.15.

### Example 14: Antibacterial and Antifungal Efficacy of Cu₂O and CuO Films

### Growth of Bacterial Strains

Bacterial strains were grown 5 mL in Tryptic Soy Broth (TSB) and mycobacterial strains in 5 mL Middlebrook 7H9 Broth to mid-exponential phase at 37° C. with aeration (60 rpm). Yeast and fungal strains were grown in Potato Dextrose Broth (PDB) to mid-exponential phase at 37° C. with aeration (60 rpm). Following growth, the purity and identity of the cells in the cultures was verified by streaking bacterial cultures on Tryptic Soy Agar (TSA), mycobacterial cultures on M7H10 agar, and yeast and fungal cultures on Potato Dextrose Agar (PDA), and incubated at 37° C. for 48 hr.

### Preparation of Microbial Strains for Testing

Grown cells were collected by centrifugation (5,000×g for 20 min), the supernatant medium discarded and the cells suspended cells in 5 mL of sterile Phosphate-Buffered Saline (PBS) by vortexing 60 sec. Those suspensions were centrifuged (5,000×g for 20 min), the supernatant wash discarded, and the washed cells suspended in 5 mL of sterile PBS by vortexing 60 sec. the number of colony-forming units (CFU)/mL of each washed suspension was measured by spreading 0.1 mL (in duplicate) of serial dilutions on: TSA (bacteria), M7H10 Agar (mycobacteria), PDA (yeast and fungi).

### Measurement of Cell Number

Cell number of PBS-suspensions of both bacteria and yeast were measured as colony-forming units (CFU)/mL of suspension. A 10-fold dilution series will be prepared for each PBS suspension, 0.1 mL of each of the dilutions (and undiluted) will be spread on TSA (bacteria) and PDA (yeast) in triplicate, and colonies will be counted after 48 hr. incubation at 37° C.

### Preparation of Cu₂O and CuO Surfaces

Stainless steel pieces, 0.5×0.5 inches, were prepared.

### Measurement of Surface Killing

For each microbial strain, 4 individual Cu₂O-coated, CuO-coated, and stainless steel surfaces were spotted with 10 μL of a PBS suspension. Immediately after drying, one surface of each type (i.e., uncoated, coated with Cu₂O, coated with CuO) was transferred to a sterile 50 mL centrifuge tube containing 5 mL of sterile PBS, sonicated for 5 min, and the CFU/mL of the suspension measured as described above. After 1, 2, and 3 hr one surface of each type was be processed in the same way. Following 48 hr. incubation of the plates (14 days for Mycobacterium spp.), colonies were counted, and the number of surviving cells expressed as CFU/mL of suspension calculated. Results are presented as % (CFUcoated/CFUsteel) where CFUsteel is a measurement on uncoated stainless steel and CFUcoated is the measurement on coated stainless steel at the same time point. This is a metric of the survival of the microorganisms. Results are presented in Table 1 below:

TABLE 1
Microbial Killing by Activity of Cupric (CuO)
and Cuprous (Cu₂O) Surfaces

| | | % (CFUcoated/CFUₛₜₑₑₗ) | |
|---|---|---|---|
| Strain | Hour* | CuO | Cu₂O |
| Staphylococcus aureus | 0 | 51. | 0.16 |
| | 1 | 0.3 | 0.3 |
| | 2 | <0.1 | <0.1 |
| Methicillin-Resistant | 0 | 3.0 | 0.1 |
| Staphylococcus aureus | 1 | <0.1 | <0.1 |
| | 2 | <0.1 | <0.1 |
| Escherichia coli | 0 | 34. | 7.0 |
| | 1 | <1.4 | <1.4 |
| | 2 | <1.4 | <1.4 |
| Pseudomonas aeruginosa | 0 | 105. | <0.2 |
| | 1 | <0.2 | <0.2 |
| | 2 | <0.2 | <0.2 |
| Stenotrophomonas maltophilia | 0 | 158. | 173. |
| | 1 | <2.0 | <2.0 |
| | 2 | <2.0 | <2.0 |
| Acinetobacter baumannii | 0 | 172. | 14. |
| | 1 | 22. | <1.4 |
| | 2 | <1.4 | <1.4 |
| Candida albicans | 0 | 110. | 23. |
| | 1 | 0.4 | 20. |
| | 2 | <0.4 | <0.4 |
| Candida auris | 0 | 105. | 14 |
| | 1 | <0.3 | <0.3 |
| | 2 | <0.3 | <0.3 |
| Aspergillus niger | 0 | 78. | 67. |
| | 1 | 33. | 19. |
| | 2 | <1.4 | <1.4 |

*Time since contact of the droplet with the sample
<indicates that zero colonies were formed on the coated sample and the number following is the % if 1 colony were formed

### Example 15: ZnO Films Rapidly Reduce SARS-CoV-2 Activity

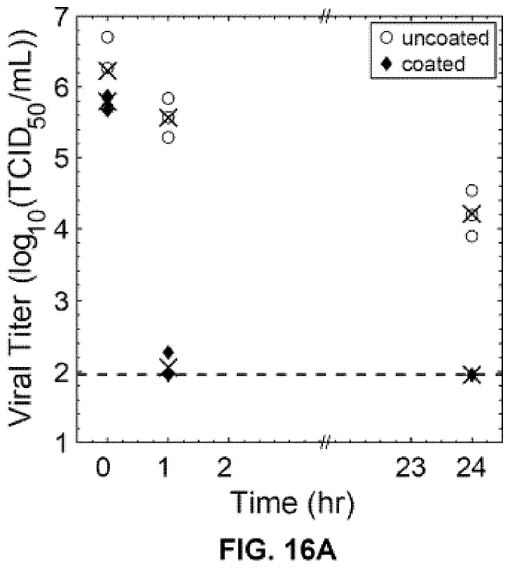

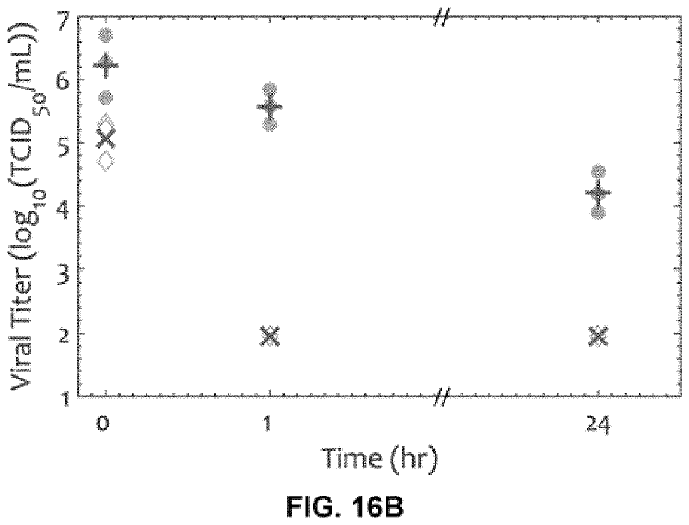

The ability of SARS-CoV-2 to infect Vero E6 cells after being deposited on ZnO is shown in FIGS. 16A-16B. Two coatings were examined, one where a coating of ZnO particles was prepared in silica produced by the sol-gel method from TEOS (ZnO/TEOS) and the other coating from zinc oxide tetrapods in polyurethane (ZnO-T/PU). In comparison to uncoated glass, the amount of virus titer experience on average 99.4% reduction on ZnO/TEOS (p=10-3, one tail, unpaired) and 99.3% reduction on ZnO-T/PU after one hour (p=7×10⁻⁵, one tail, unpaired).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Ahamed, M. et al, J. Nanomater. 2014, 5, 519.
2. Applerot, G. et al, Small 2012, 8, 3326.
3. ASTM International, ASTM D3359 Adhesion Test, 2017.
4. Azam, A. et al, Int. J. Nanomed. 2012, 7, 3527.
5. Baillot, R. et al, Reliability Investigation of LED Devices for Public Light Applications, Elsevier, 2017.
6. Behzadinasab, S. et al, ACS Appl. Mater. Interfaces 2020, 12, 34723.
7. Benavente, D. et al, Transp. Porous Media 2002, 49, 59.
8. Biesinger, M. C., Surf. Interface Anal. 2017, 49, 1325.
9. Borkow, G. et al, Curr. Chem. Biol. 2009, 3, 272.
10. Cai, J. et al, Transp. Porous Media 2011, 89, 251.
11. Chan, K. et al, J. Clin. Virol. 2009, 45, 205.
12. Chen, X. et al, ACS Appl. Mater. Interfaces 2017, 9, 39165.
13. Chin, A. et al, Lancet Microbe 2020, 1, e146.
14. COVID-19 Dashboard by the Center for Systems Science and Engineering (CSSE) at Johns Hopkins University (JHU), https://coronavirus.jhu.edu/map.html, accessed: Sep. 22, 2020.
15. Cui, L. et al, ACS Appl. Mater. Interfaces 2012, 4, 2775.
16. Dasari, T. P. et al, J. Environ. Sci. 2013, 25, 882.
17. Deegan, R. D. et al, Nature 1997, 389, 827.
18. Deegan, R. D. et al, Phys. Rev. E 2000, 62, 756.
19. Derraik, J. G. et al, Int. J. Environ. Res. Public Health 2020, 17, 6117.
20. Ethiraj, A. S. et al, Nanoscale Res. Lett. 2012, 7, 70.
21. Fathizadeh, H. et al, Infez. Med. 2020, 28, 185.
22. Gittings, S. et al, Eur. J. Pharm. Biopharm. 2015, 91, 16.
23. Goldsmith, C. S. et al, Emerging Infect. Dis. 2004, 10, 320.
24. Han, Z. et al, Interface 2013, 10, 20130560.
25. Hans, M. et al, Biointerphases 2015, 11, 018902.
26. Hans, M. et al, Langmuir 2013, 29, 16160.
27. Hari Prasad Reddy, M. et al, Phys. Status Solidi A 2012, 209, 1279.
28. Huber, P. et al, Eur. Phys. J.: Spec. Top. 2007, 141, 101.
29. lijima, Y. et al, Surf. Interface Anal. 1996, 24, 193.
30. Janas, J. et al, Appl. Catal., B 2009, 91, 217.
31. Johnson, G. et al, J. Aerosol Sci. 2011, 42, 839.
32. Li, K. et al, SPE J. 2004, 9, 322.
33. Liu, Z. et al, J. Med. Virol. 2020, 92, 595.
34. Luo, J. et al, Biointerphases 2017, 12, 020301.
35. Malenovska, H., J. Virol. Methods 2013, 191, 136.
36. Meghana, S. et al, RSC Adv. 2015, 5, 12293.
37. Mittapally, S. et al, J. Drug Delivery Ther. 2018, 8, 411.
38. Morawska, L. et al, J. Aerosol Sci. 2009, 40, 256.
39. Otter, J. et al, J. Hosp. Infect. 2016, 92, 235.
40. Papineni, R. S. et al, J. Aerosol Med. 1997, 10, 105.
41. Parmigiani, F. et al, J. Electron Spectrosc. Relat. Phenom. 1992, 59, 255.
42. Polak, M. et al, Adv. Eng. Mater. 2010, 12, B511.
43. Prasad, S. et al, Indian J. Med. Res. 2020, 151, 241.
44. Prat, M., Int. J. Heat Mass Transfer 2007, 50, 1455.
45. Rantonen, P. J. et al, Acta Odontol. Scand. 1998, 56, 210.
46. Ratanadecho, P. et al, J. Heat Transfer 2002, 124, 151.
47. Reed, L. J. et al, Am. J. Epidemiol. 1938, 27, 493.
48. Ren, G. et al, Int. J. Antimicrob. Agents 2009, 33, 587.
49. Scharfman, B. et al, Exp. Fluids 2016, 57, 24.
50. Semisch, A. et al, Part. Fibre Toxicol. 2014, 11, 1.
51. Sia, S. F. et al, Nature 2020, 583, 834.
52. SMARTLAB, Material Safety Data Sheet Copper (II) oxide, 2018.
53. Song, G. et al, Bot. Stud. 2016, 57, 1.
54. Sunada, K. et al, J. Hazard. Mater. 2012, 235-236, 265.
55. US Centers for Disease Control and Prevention, Cleaning and Disinfection for Households, https://www.cdc.gov/coronavirus/2019-ncov/prevent-getting-sick/cleaning-disinfection.html, accessed: Aug. 30, 2020.
56. Van Doremalen, N. et al, N. Engl. J. Med. 2020, 382, 1564.
57. Wang, W. Z. et al, Adv. Mater. 2002, 14, 67.
58. Weon, B. M. et al, Phys. Rev. E 2010, 82, 015305.
59. Wilson, N. et al, Anaesthesia 2020, 5, 1086.
60. Xie, X. et al, Interface 2009, 6, S703.
61. Yang, S. et al, J. Aerosol Med. 2007, 20, 484.
62. Zhang, J. et al, Chem. Mater. 2006, 18, 867.
63. Zhang, Q. et al, Prog. Mater. Sci. 2014, 60, 208.
64. Zhou, K. et al, Nanotechnology 2006, 17, 3939.

1. An antimicrobial film comprising a metal or metal oxide and a matrix, wherein the metal or metal oxide contacts the matrix; wherein the matrix comprises a polymer comprising polydopamine, polyurethane, or a derivative thereof.

2-3. (canceled)

4. The antimicrobial film of claim 1, wherein the metal comprises Ag, Cu, Zn, or any combination thereof.

5. The antimicrobial film of claim 1, wherein the metal oxide comprises CuO, Cu₂O, ZnO, MgO, TiO₂, Ag₂O, Fe₂O₃, Sb₂O₃, Al₂O₃, or any combination thereof.

6. The antimicrobial film of claim 1, wherein the metal or metal oxide comprises particles having an average diameter in at least one dimension of from about 0.5 μm to about 50 μm.

7. (canceled)

8. The antimicrobial film of claim 1, wherein the matrix comprises an exterior surface and an interior surface, and wherein the interior surface comprises a plurality of pores in communication with the exterior surface.

9-13. (canceled)

14. The antimicrobial film of claim 1, wherein the polydopamine derivative comprises a polymer comprising monomer units selected from 3,4-dihydroxy-L-phenylalanine, norepinephrine, 2-bromo-N-[2-(3,4-dihydroxyphenyl)ethyl]-2-methyl propenamide, 6-nitrodopamine, or any combination thereof.

15. The antimicrobial film of claim 1, wherein the polymer comprises polyurethane and the metal oxide comprises Cu₂O.

16. The antimicrobial film of claim 1, wherein the polymer comprises polydopamine and the metal oxide comprises Cu₂O.

17. The antimicrobial film of claim 1, wherein the polymer comprises polydopamine and the metal oxide comprises Ag₂O.

18-25. (canceled)

26. The antimicrobial film of claim 1, wherein the film remains hydrophilic after at least four months of use.

27-29. (canceled)

30. The antimicrobial film of claim 1, wherein the film has a thickness of from about 5 μm to about 100 μm.

31. (canceled)

32. The antimicrobial film of claim 8, wherein the individual pores of the plurality have an average diameter of from about 1 μm to about 50 μm.

33. (canceled)

34. The antimicrobial film or claim 8, comprising a pore volume of from about 50% to about 70% of total film volume.

35-46. (canceled)

47. The antimicrobial film of claim 1, wherein the antimicrobial film is recyclable.

48-133. (canceled)

134. The antimicrobial film of claim 1, wherein the antimicrobial film is transparent.

135. (canceled)

136. An article comprising the antimicrobial film of claim 1.

137. The article of claim 136, wherein the article comprises a light switch, a door handle, a faucet handle, a railing, a piece of medical equipment, a bed rail, a cooking or food preparation surface, a surface in a retail store, a mass transit vehicle surface, an automobile surface, a hospital surface, a smartphone, a tablet computer, a cover for a personal electronic device, a computer mouse, a keyboard, a touch-screen, a screen protector for a touch-screen, a retail check-out facility or device, furniture, carpet, upholstery, equipment or machinery control surfaces, food packaging, athletic equipment, toilet seats, toilet flushing handles, communal religious articles, a packaging material, personal protective equipment, a filter, an article of apparel, an elevator button, a mirror, an acrylic divider, a polycarbonate surface, a sapphire surface, or any combination thereof.

138. The article of claim 137, wherein the personal protective equipment comprises a lab coat or a face mask.

139. The article of claim 137, wherein the filter comprises an air purification filter.

140. (canceled)

141. The antimicrobial film of claim 1, further comprising a substrate comprising a plurality of pores in communication with an exterior surface of the substrate, wherein the matrix forms a coating on at least a portion of the individual pores of the plurality, the exterior surface of the substrate, or both.
